(19) United States
(12) Patent Application Publication
(10) Pub. No.: US 2014/0135961 A1
(43) Pub. Date: May 15, 2014

(54) Theory of ac-games, a simple generalization of the theory of c-games

(71) Applicant: Ioannis Boultis, Thessaloniki (GR)

(72) Inventor: Ioannis Boultis, Thessaloniki (GR)

(21) Appl. No.: 14/100,024

(22) Filed: Dec. 9, 2013

Related U.S. Application Data
(63) Continuation-in-part of application No. 13/407,761, filed on Feb. 29, 2012.
(60) Provisional application No. 61/449,652, filed on Mar. 5, 2011.
(60) Provisional application No. 61/502,860, filed on Jun. 30, 2011.
(60) Provisional application No. 61/589,799, filed on Jan. 23, 2012.
(60) Provisional application No. 61/735,060, filed on Dec. 10, 2012.

(51) Int. Cl. G06Q 10/04

(52) U.S. Cl. CPC G06Q 10/04
USPC 700/93

(57) ABSTRACT

This is a simple generalization of the theory of c-games. A differential game is interpreted as a many person game where two or more coalitions are formed. A coalition change is defined in this case and the time this happens, also called c-time, is introduced. The quantities used to formulate the c-games and the methods introduced to obtain optimal c-times and optimal variables in general, apply in the present case without modification or with some very minor and obvious changes of the definitions used in c-games.

### CROSS-REFERENCE TO RELATED APPLICATIONS

1) This application is a continuation in part of the non provisional application with application Ser. No. 13/407,761 and filling date Feb. 29, 2012, which claimed the benefits of the following three US provisional applications:

provisional with application No. 61/449,652 and filing date Mar. 5, 2011,
provisional with application No. 61/502,860 and filing date Jun. 30, 2011, and
provisional with application No. 61/589,799 and filing date Jan. 23, 2012.

2) This application claims the benefit of the US provisional application with application No. 61/735,060 and filing date Dec. 10, 2012.

3) This application claims the benefit of the following three US provisional applications:

provisional with application No. 61/449,652 and filing date Mar. 5, 2011,
provisional with application No. 61/502,860 and filing date Jun. 30, 2011, and
provisional with application No. 61/589,799 and filing date Jan. 23, 2012.

### TECHNICAL FIELD

Theory of differential games, many players in differential games, coalitions in differential games, coalition changes in differential games.

### BACKGROUND ART

In “Handbook of Game Theory with economic applications, Aumann-Hart editors, vol. 2, chapters 22 and 23” there are some examples of N-person differential games. There are given N payoff functions and the Nash equilibrium is formulated, constrained by differential equations. See also the references there. There is also a chapter in A. Friedman's book “Differential Games, John Wiley 1971, Dover 2006” that deals with many person differential games, and the definitions there are used in this paper.

### SUMMARY

The theory of ac-games is quite trivial generalization of the theory of c-games that is a mathematical formulation of the concept of changing coalitions in many person differential games. The theory of c-games uses differential games as formulated by Isaacs as building blocks of the coalition changes. In a way similar to the one used in c-games one can us as building blocks Isaacs differential games and general n person games that can be solved by Nash equilibrium (Friedman “Differential Games”). This generalization requires small modifications in some definitions used in the c-games.

### BRIEF DESCRIPTION OF THE DRAWINGS

There are seven drawings, FIG. 1 until FIG. 7.

The drawings FIG. 1, FIG. 2, and FIG. 3 show the subproblems at steps k=2, k=1 and k=0 respectively of an example of the general recursive method.

The drawings FIG. 4, FIG. 5, and FIG. 6 show the subproblems at steps k=3, k=2 and k=1 and 0 respectively of an example of a recursive method when the subproblems are ac1-subgames or ae-games.

FIG. 7 show the subproblems at steps k=3, k=2, k=1 and k=0 of an example of a recursive method when the subproblems are ac1-subgames.

### DISCLOSURE OF INVENTION

A quite trivial generalization of the theory of c-games to include many player differential games can be given. The only quantities one has to modify is the definition of an e-game, the definition of a c-change, and introduce the sets of non-Nash and non-optimization variables and the way players control those. The rest of the definitions in the formulation of the c-game and the solutions remain the same.

The Generalization of Elementary Coalitions or e-Coalitions, the ae-Coalitions.

One introduces the sets Nr(a) of players in each differential game, where r takes all values in a set R(a)={1, 2, . . . , maxR(a)}, maxR(a)≧1, the case=1 corresponds to the case where the elementary game is a se-game, that is a control problem.

The sets Nr(a) are interpreted as elementary coalitions of players, and called ae-coalitions or abstract elementary coalitions. They are subsets on the set N of all players in the ac-game, and are pairwise disjoint. These generalize the sets N1(a) and N2(a), the e-coalitions of e-games.

The Generalization of an e-Game, the ae-Game.

The ae-game is by definition either an e-game (as defined in the c-games) or a ne-game or a se-game. The definitions of se- or ne-games follow that of an e-game.

The ne-game contains:
a. The sets of players Nr(a), r in R(a) and R(a) has two or more elements.
b. The set of all players N(a)=∪Nr(a), the union is over all r in R(a).
c. The subset ADN(a) of N(a), that is the set of players that control the additional variables.
d. The subset NNN(a) of N(a), that is the set of players that control the non-Nash variables, and
e. A many person differential game, as can be found in “Friedman: Differential Games, Chapter 8: N-person games”, that contains:
   e1. The sets of functions Φr(t), controlled by elementary coalitions Nr(a) respectively,

Φr(t)={φr1(t), . . . , φrp(r)(t)},
and their union called set of control function variables of the ne-game.
e2. The payoff functions Pr(Φs(t)), of the elementary coalitions Nr(a) respectively,

Pr(Φs(t))=∫(Gr(X(t),Φs(t)))dt+Hr
e3. A solution method, called Nash equilibrium in Friedman, to obtain optimal control functions. Methods to solve this kind of games and cases where one can obtain solutions can be found in the literature, for example in Friedmans book mentioned before.
e4. The value functions Vr, called equilibrium value functions in Friedman.
   This completes the definition of the ne-game.

The se-game contains:
a′. The sets of player Nr(a), r in R(a) and R(a) is an one element set.
b′. The set of all players N(a)=Nr(a).
c′. The subset ADN(a) of N(a), that is the set of players that control the additional variables.
d′. The subset NON(a) of N(a), that is the set of players that control the non-optimization variables, and
e′. A control, equivalently optimization, problem that contains:
   e1′. The set Φ(t) of functions controlled by the elementary coalition Nr(a)

Φ(t)={φ1(t), . . . , φp(r)(t)},
called set of control function variables of the se-game.
e2′. A payoff function P(Φ(t))

P(Φ(t))=∫(G(X(t),Φ(t)))dt+H
e3′. A solution method to obtain optimal control functions Φ*(t). Methods to solve this kind of problems can be found in the literature.
e4′. The optimal payoff P(Φ*(t)), that can be called value function V.
   This completes the definition of the se-game.

The Generalization of an c-Change, the ac-Change

Given the ae-game one can define the c-time as in the case of c-games, but the definition of the e-coalition change must change because there are might be more sets of players involved than two.

Thus an ac-change ((a, b)) is defined as an ordered pair of ae-games where the differential game in the first is interrupted at time t(a, b), called in this case also c-time, the second begins at t(a, b), and the set

{{Nr(a):r in R(a)},{Ns(b):s in R(b)}}

that contains the sets of players in the two differential games satisfies a relation called ae-coalition change and is given in the following:
a. there exist subsets LEAVE(r, a) of Nr(a) that consist of the players that leave the first differential game and do not join the second,
b. there exist subsets CHANGE(r, a;s, b) of Nr(a) that consist of the players that leave the elementary coalition Nr(a) in the first differential game and join the Ns(b) in the second,
c. there are sets JOIN(s, b) that consist of players that don't play in a and join b, thus are subsets on N\N(a). And finally
d. Ns(b)=JOIN(s,b)∪(∪r CHANGE(r,a;s,b))
   Relation (d) tells that the elementary coalition Ns(b) is formed by the players in CHANGE(r, a; s, b), that left coalition Nr(a) to join Ns(b), for any r, and the players in JOIN(s, b) that didn't play in a. ∪r denotes the union over all r.

In the provisional, which this application claims the benefits of and where the case of ne-games was presented, the indexes j, k were used instead of r, s, the sets Nr(a), Ns(b) were denoted by N(j, a), N(k, b), the sets LEAVE(r, a) by A(j, a), the sets CHANGE(r, a; s, b) by B(j, k, a, b) and JOIN(s, b) by D(k, b).

Properties of the ae-Coalition Change.

Since the sets in [0004] must describe a change of coalitions, the following relations must be satisfied:
a. A player in Nr(a) either leaves a and don't play in b or leaves a and plays in b, thus, for all r in R(a) and all s in R(b),

LEAVE(r,b)∩CHANGE(r,a;s,b)=Ø.
b. A player in Nr(a) that leaves a and plays in b can join one only elementary coalition in b, thus for all s, s′ in R(b) and all r in R(a),

CHANGE(r,a;s,b)∩CHANGE(r,a;s′,b)=Ø.
c. A player that doesn't plays in a must join only one coalition in b, thus for all s, s′ in R(b),

JOIN(s,b)∩JOIN(s′,b)=Ø.

The Relation Between the c-Change and the ac-Change.

One can obtain the definition of a c-change ((a, b)) from an ac-change ((a, b)), when both ae-games are e-games, by defining the following sets, used in the definition of c-change:

R(a)={1,2}

R(b)={1,2}

LEAVE(1,a)=A1(a),

CHANGE(1,a;2,b)=A2(a),

CHANGE(1,a;1,b)=(N1(a)\(A1(a)∪A2(a)),

LEAVE(2,a)=B1(a),

CHANGE(2,a;1,b)=B2(a),

CHANGE(2,a;2,b)=(N2(a)\(B1(a)∪B2(a)),

JOIN(1,b)=D1(b),

JOIN(2,b)=D2(b),

N1(b)=(N1(a)\(A1(a)∪A2(a)))∪B2(a)∪D1(b), and

N2(b)=(N2(a)\(B1(a)∪B2(a)))∪A2(a)∪D2(b).

The Tree.

Given the definition of ac-change one can define the ordered tree that consists of all ae-games (its vertices) and all ac-changes (its edges) as usually, and with the usual interpretation that the tree describes all possible coalition changes starting from one differential game, the root of the tree.

The Realizations.

These are defined as in the case of c-games. Thus they are sequences of ae-games that begin at the root, end at a leaf and for any pair of ae-games (a(n), a(n+1)) in the sequence the ac-change exists.

The order of ae-games, the c1-subgames (now called ac1-subgames), the realizations of ac1-subgames are defined exactly as in the case of a c-game.

The realizations can be numbered and the ac-game can be written in realization or tree form in ways identical with those in the case of the c-games.

The Set of Variables VAR.

The set of all variables is defined similar to the case of c-games. It contains all c-times defined in [0004], all additional variables defined exactly as in the case of c-games, and if the ae-game is an e-game all non-Isaacs variables defined in the c-game theory, if the ae-game is a se-game all non-optimization variables and furthermore if the ae-game is a ne-game all non-Nash variables.

The non-Nash variables are defined in a similar way as the non-Isaacs variables, that is we solve the differential game by the Nash equilibrium, assign to all control variables their value obtained from the Nash equilibrium and then consider some of them, called non-Nash variables, as variables again to be determined from the solution of the ac-game.

The non-optimization variables are defined by: we solve the optimization problem, assign to all control variables their optimal values and then consider some of them, called non-optimization variables, as variables again to be determined from the solution of the ac-game.

The set of non-Nash variables is denoted by NNVAR and is equal to the union ∪NNVAR(a), where NNVAR(a) is the set of non-Nash variables of the ne-game a and the union is over all ne-games a in the tree.

The set of non-optimization variables is denoted by NOVAR and is equal to the union ∪NOVAR(a), where NOVAR(a) is the set of non-optimization variables of the se-game a and the union is over all se-games a in the tree.

The Domains of Variables.

The domains of variables, the domain DCT of ac-times, and the domains DCT(j) that correspond to realizations are defined exactly as in the c-game theory.

The Sets VARS(Mi).

The definitions of the sets VARS(Mi) of variables controlled by a c-coalition Mi needs a slight modification. The sets VARS(Mi) satisfy identical properties as in the theory of c-games.

The set of additional variables controlled by Mi is defined as in the theory of c-games.

The set of c-times controlled by Mi is defined in a way similar to the one in the theory of c-games:
we say Mi controls t(a, b) if at least one player in Mi belongs also in the union of the sets LEAVE(r,a), CHANGE(r,a;s,b) and JOIN(s,b)
   where the union is over all r in R(a) and all s in R(b).

The set of non-Isaacs variables controlled by Mi in case the ae-game is an e-game is defined as in the theory of c-games.

The set of non-Nash variables controlled by Mi in case the ae-game is a ne-game is defined in a way similar to the one for non-Isaacs variables in the theory of c-games:

we say Mi controls a non-Nash variable z if
a. there is a ne-game a,
b. the variable z is in the set NNVAR(a) of non-Nash variables of ne-game a,
c. z is in the set NNVAR(Mi, a) of non-Nash variables controlled by Mi, and
d. there is at least one player m in Mi that belongs in the set NNN(a) of players that control the non-Nash variables in a.
   In the provisional the sets NNVAR(a) and NNN(a) were denoted by NOOPT(a) and NIN(a).

The set of non-optimization variables controlled by Mi in case the ae-game is a se-game is defined by:

we say Mi controls a non-optimization variable z if
a′. there is a se-game a,
b′. the variable z is in the set NovAR(a) of non-optimization variables of a,
c′. z is in the set NOVAR(Mi, a) of non-optimization variables controlled by Mi,
d′. there is at least one player m in Mi that belongs in the set NON(a) of players that control the non-optimization variables in a.

The Payoffs.

These are defined as in the theory of c-games as functions of variables in VAR, and satisfy identical properties as in the theory of c-games.

The Axiom.

The definition of the axiom is identical to the one in the c-game, one has only to replace the e-games by ae-games.

The ac-Game.

This is defined as the c-game and contains:
a. The set N of all players in the ac-game.
b. The c-coalitions Mi.
c. The algebraic ac-game.
d. The set VAR of variables in the ac-game, that contains the set DCT where the c-times take values.
e. The domains where the variables in VAR take values and the subsets DCT(j).
f. The sets VARS(Mi) of variables controlled by the c-coalition Mi.
g. The payoff functions P(Mi) of the c-coalitions Mi.
h. And finally the axiom.
   These quantities satisfy similar properties to the ones in the c-game definition.

The Algebraic ac-Game.

This is defined as in the c-game case and contains:

a. The ae-games.
b. The ordered tree structure.
c. And finally the realizations.

The Solution of ac-Games.

Since the solutions defined in the theory of c-games use only the payoffs of the c-coalitions P(Mi), the domains of variables and the sets VARS(Mi), and don't use the e-game, one can apply these definitions in the case of ac-games as they are in the theory of c-games.

An Example of the Mixed Recursive Method.

In FIGS. 1, 2 and 3 a graphical example is shown of the general recursive method. In this case there are three steps, K={0,1,2}, and for each step assume there are the problems

### L(0)=NPURL(0)={0}

### L{1}=ELL(1)={1}

### L(2)=GMIXL(2)∪EGGPURL(2), GMIXL(2)={2} and EGGPURL(2)={3}

Assume also that to set of c-coalitions M(i) in the recursive solution is given by I={1,2,3,4,5}, the set of c-coalitions M(i) in the (k,l(k))=(0,0) subproblem is given by I(0,0)={1,3,4,5}. Similarly for the other (k,l(k))-subproblems the I(k,l(k)) are I(1,1)={1,3,5}, I(2,2)={1,3}, I(2,3)={2,4}.

There is a partition VAR(0,0), VAR(1,1), VAR(2,2) and VAR(2,3) of the set of variables VARS.

The subproblems (2,2) and (2,3) are shown inside dashed lines in FIG. 1. The subproblem (2,2) is solved as follows. The set VAR(2,2) contains the c-times s41, s42, s43. The payoff PAY(2,2) is given and depends on parameters in PAYPAR(2,2) and this set may contain the c-times s31, s32, s33 and other variables in VAR(0,0) and VAR(1,1). PAY(2,2) defines also the functional EXPPAY(2,2). A zero sum game is formulated

| | | |
|---|---|---|
| max | min | EXPPAY(2,2) |

PROBM(1(2,2)) PROBM(3(2,2))

and solved and the optimal measures are OPTPROBM(2, 2, i), i=i(2,2) in I(2,2)={1,3}, these measures are on the variables in VAR(2,2) thus also on c-times s41, s42, s43. The optimal measures depend on parameters in OPTPROBPAR(2,2, i), i in {1,3}, that is a subset of PAYPAR(2,2) and may contain the c-times s31, s32, s33.

The subproblem (2,3) is solved as follows. The set VAR(2,3) contains the c-times s34, s35. The payoffs of the c-coalitions are PAY(2,3,i), i=i(2,3) in I(2,3)={3,4}, and depend on parameters in PAYPAR(2,3,i) and this set may contain the c-time t14 and other variables in VAR(0,0) and VAR(1,1). EGGPURL_FUN(2,3) can be PAY(2,3,3)−PAY(2,3,4) and this defines also the functional EXPPAY(2,3). First the problem is solved using the upper and lower empirical solutions to obtain the points TEL(2,3) and TEU(2,3) (or TEL1(2,3) and TEU1(2,3)), these values can depend on parameters in PAYPAR(2,3). Then a zero sum game is formulated

| | |
|---|---|
| MAX | MIN EGGPURL_FUN(2,3), |

VARM(3(2,3)) VARM(4(2,3))

which we solved in the interval [TEL(2,3), TEU(2,3)] and the optimal variables are OPTVAR(2, 3, z) where z is s34, s35 and other variables in VAR(2,3). Each OPTVAR(2,3,z) depends on parameters in OPTVARPAR(2,3,Z) that is a subset of PAYPAR(2,3) and may contain the c-times t14.

The subproblem (1,1) is shown inside dashed lines in FIG. 2. The set VAR(1,1)={s31, s32, s33}, ie consists of c-times. The payoffs of the c-coalitions are PAY(1,1,i), i=i(1,1) in I(1,1)={1,3,5}. Each payoff depends on parameters in PAYPAR(1,1,i) and this set may contain the c-time t12 and other variables in VAR(0,0). Using the payoffs PAY(1,1,i) one can obtain the lower empirical solution ELS(1,1)=(TEL(1,1)), j(TEL)(1,1)) where j(TEL)(1,1) is the realization that players will choose and TEL(1,1) the c-time they'll make the change. Using the function ELL_ASIGNVAR(1,1), that it is assumed it exists, one can obtain the optimal values OPTVAR(1,1,s31), OPTVAR(1,1,s32), OPTVAR(1,1,s33) of all c-times s31, s32, s33, the value TEL(1,1) is assigned to the c-time that corresponds to realization chosen and arbitrary values larger TEL(1,1) are assigned to the other two. The optimal variables depend on parameters in PAR(1,1).

Finally the subproblem (0,0) is shown inside dashed lines in FIG. 3. VAR(0,0) contains the c-times t01, t02, t03, t11, t12, t13, t14. PAYPAR(0,0) is vacuum, PAY(0,0,i), i=i(0,0) in I(0,0)={1,3,4,5}, are given and contain variables in VAR (0,0).

A Nash problem

| | |
|---|---|
| max | PAY( 0,0,i) , i=1,3,4,5. |

VARM(i(0,0))

is solved and the optimal variables are OPTVAR(0,0,z) where z is a variable in VAR(0,0) and this can be one of the c-times t01, t02, t03, t11, t12, t13, t14.

The recursive optimal variables are calculated recursively as follows: RECOPTVAR(0,0,z(0,0))=OPTVAR(0,0,z(0,0)). RECOPTVAR(1,1,z(1,1))=OPTVAR(1,1,z(1,1)) where each parameter z′ in OPTVARPAR(1,1,z(1,1)) takes the value RECOPTVAR(0,0,z′). RECOPTVAR(2,3,z(2,3))=OPTVAR(2,3,z(2,3)) where each parameter z′ in OPTVARPAR(2,3,z(2,3)) takes either the value RECOPTVAR(0,0,z′) if z belongs in VAR(0) or the value RECOPTVAR(1,1,z′) if z belongs in VAR(1). RECOPTPROBM(2,2,i(2,2))=OPTPROBM(2,2,i(2,2)) where each parameter z′ in OPTPROBMPAR(2,2,i(2,2)) takes either the value RECOPTVAR(0,0,z′) if z′ belongs in VAR(0) or the value RECOPTVAR(1,1,z′) if z′ belongs in VAR(1).

The recursive optimal payoff is defined as follows:

There exist functions F(i) that depend on variables z(k,l(k)) for each i in {1,2,3,4,5}. The pure variables z(k,l(k)) in F(i) take the values RECOPTVAR(k,l(k), z(k,l(k))) and the resulting expression is integrated with respect to the measure RECOPTPROBM(2,2,i(2,2)), thus EXPRECF(i) is obtained.

Since the formulation of the recursive method contains the arbitary optimal values in ELL(k) problems, in order to obtain unique solutions the following condition must be satisfied:

If EXPRECF(i) depends on a c-time, say t(3), in an ELL subproblem then it depends on all c-times t(1), t(2), t(3), t(4), . . . of said subproblem and

$$EXPRECF ( i ) ( t ( 1 ) , t ( 2 ) , t ( 3 ) , t ( 4 ) , … ) == EXPRECF ( i ) ( min \{ t ( 1 ) , t ( 2 ) , t ( 3 ) , t ( 4 ) , … \} ) .$$

This is a very reasonable condition in ac-games, and we usually require this to be satisfied for all c-times in all ac1-subgames, regardless they are solved by empirical or other method. Because once an e-coalition change happens say at t(3)=5 and the realization A(3)=(a,b(3)) is chosen, thus players play ae-game b(3) after ae-game a, it doesn't matter if t(2) takes the value t(2)=7 or t(2)=2000. The payoffs that use sigma functions have this property. This condition was introduced before, in a case of payoffs for c-games.
Generally we require in several occasions that:
if a function, say FUNCT, depends on a c-time t′ that belongs in a ac1(a′)-subgame where a′ is an ae-game in the ac-game,
then FUNCT depends an all c-times of the ac1(a′)-subgame, and
   if {t′1,t′2,t′3, . . . } is the set of these c-times
   then

$$FUNCT ( {t}^{′} 1 , {t}^{′} 2 , {t}^{′} 3 , … ; OZ ) == FUNCT ( min \{ {t}^{′} 1 , {t}^{′} 2 , {t}^{′} 3 , … \} ; OZ ) ,$$

where OZ denotes the other variables of the function FUNCT.

An Example of the Recursive where the Subproblems are ac1-Subgames and ae-Games.

FIGS. 4 until 6 show the recursive method where a subproblem is associated with each ae-game. If the ae-game a(k,l) is a leaf then by the solving the subproblem one will obtain the optimal values of additional or say non Isaacs variables of the differential game in the ae-game as functions of the time the differential game begins, said time is a c-time. If the ae-game a(k,l) is not a leaf then the subproblem is a ac1-subgame with root the a(k,l) ae-game.

In FIGS. 4, 5, 6 the k=3, 2, 1, 0 subproblems are shown. In case the subproblem is a ac1-subgame the functions PAY(M(i), k, l(k)) are defined by using known quantities and quantities defined in the previous step k+1.

In FIG. 4 the different k=3 subproblems are shown by the dashed lines, and all these subproblems are ae-games. Consider the ae-game a(3,8). Denote this subproblem by (k,l(k))=(3,8). The parameter set of this problem consists of the c-time t(a(2,5),a(3,8)).

The functions P(M(i),3,8) of each c-coalition i in the (3,8)-subproblem are the c-coalition payoffs P(M(i), a(3,8)) in the ae-game a(3,8) and they are assumed given. The subproblem payoffs PAY(3,8)) or PAY(3,8,i′) can be obtained from P(M(i′),3,8), where i′ belongs in I(3,8). Then one solves the (3,8)-subproblem to obtain optimal values OPTVAR(3,8,z) for the variables z in VAR(3,8) and these can be non-isaacs, non-nash, non-optimization variables and additional variables but not c-times, as functions of the c-time t(a(2,5),a(3,8)). The way the subproblem will be solved depends on which subset of L(k=3) the index l(k=3)=8 belongs. One solves in the same way the other two k=3 subproblems.

Once the optimal values of the variables are calculated one can calculate the optimal functions OPTP(M(i), k, l(k)) for any i in I, since these are defined for any i in I. Thus this recursive method deals with the case where each c-coalition has payoff for each subproblem but don't control the variables in every subproblem and the optimal values of the variables in a subproblem are obtained by those c-coalitions who actually take part in the subproblem. The c-coalitions M(i) that take part in the (k,l(k))-subproblem satisfy: i=i(k,l(k)) belongs in I(k,l(k)) which is a subset of I.

In FIG. 5 the different k=2 subproblems are shown by the dashed lines. In case the subproblems are ae-games they are solved as in the case of FIG. 4. Consider the (2,5)-subproblem of the ac1(a(2,5))-subgame with root the ae-game a(2,5) and realizations A(j′)=(a(2,5), b(j′)), j′ in {1,2,3}. The parameter set of this problem consists of the c-time t(a(1,1),a(2,5)). One defines the functions P(M(i),2,5), for all i in I, by

P(M(i),2,5)=SUM SIG(A(j′))P(M(i),A(j′)),

P(M(i),A(j′))=P(M(i),a(2,5))+P″(M(i),b(j′)), (Formula 18.1)

where P(M(i),a(2,5)) is the known payoff of c-coalition M(i) in ae-game a(2,5), P″(M(i′),b(1)) is the optimal value OPTP(M(i),3,8) of P(M(i),3,8) defined in the previous step, and similarly for P″(M(i),b(2)) and P″(M(i),b(3)). Once these functions are given one can calculate the subproblem payoffs PAY(2,5)) or PAY(2,5,i′) using P(M(i′),2,5) where i′ belongs in I(2,5) and solve the subproblem by the appropriate method determined by the subset of L(k=2) that contains the index l(k=2)=5. The subproblems in FIG. 6 can be treated similarly.

Once the subproblem k=0, l(0)=0 is solved, the problem is solved because the optimal values of the variables in each subproblem are obtained, thus the recursive optimal values can be calculated, and the functions F(i) are defined to be the already constructed P(M(i),0,0) thus the recursive optimal payoffs can be obtained.

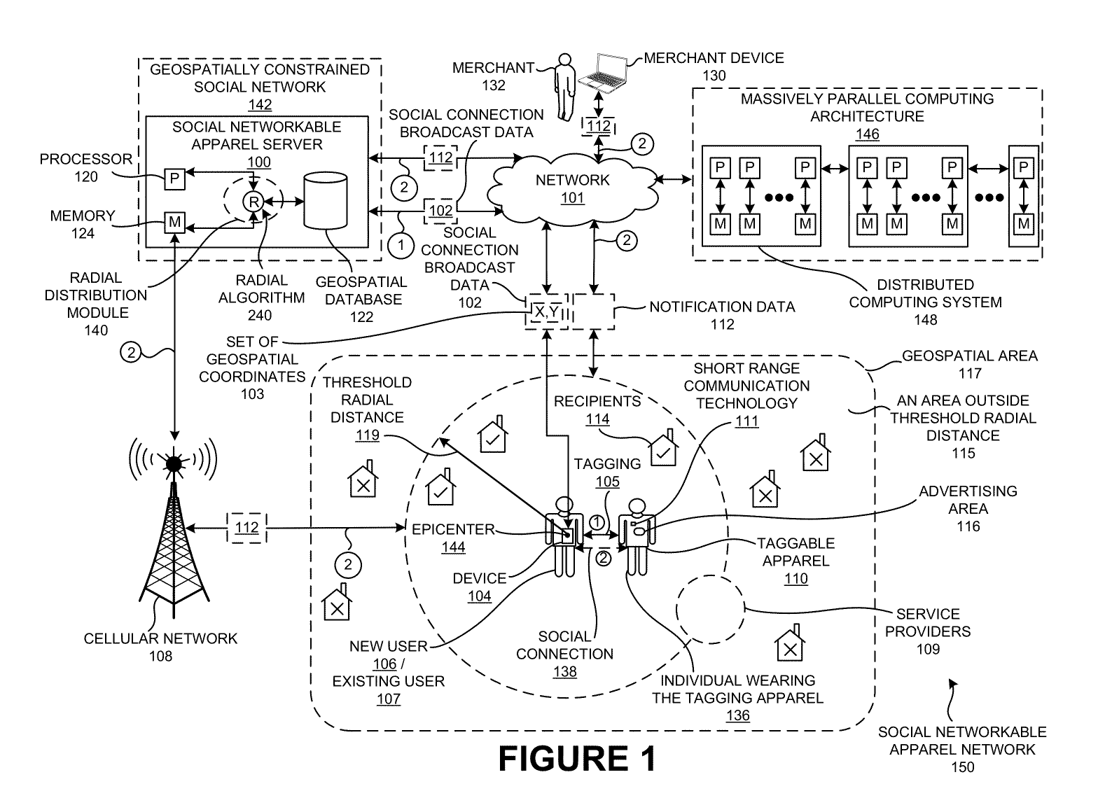

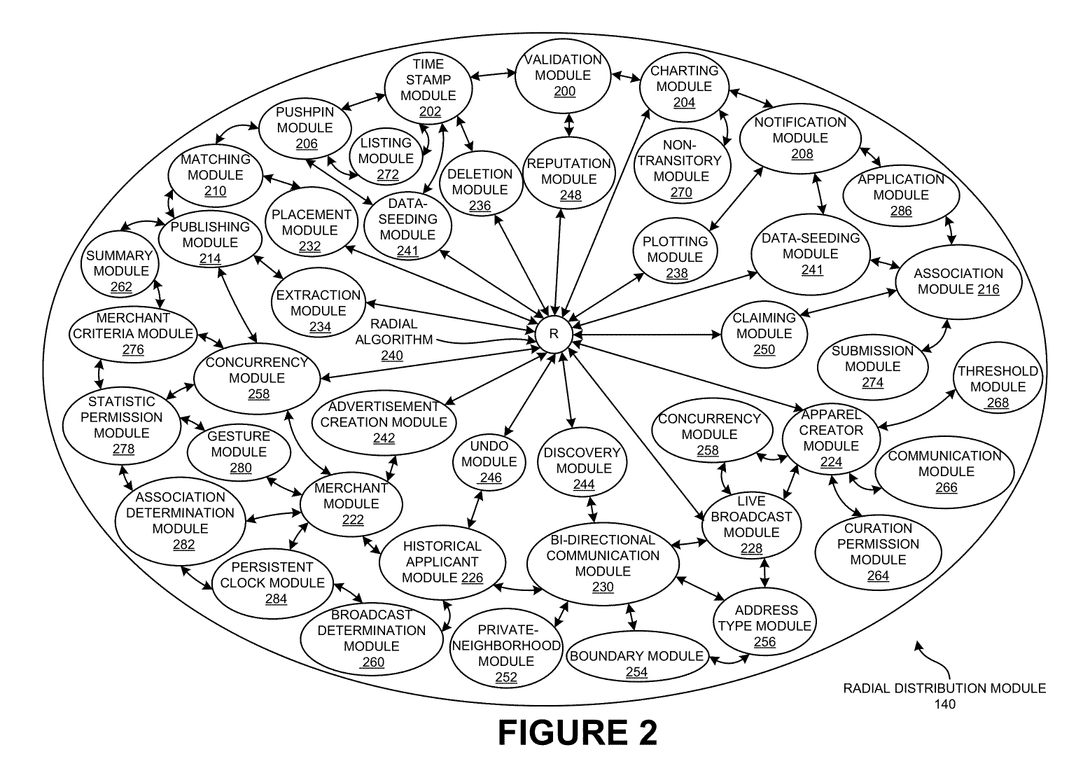

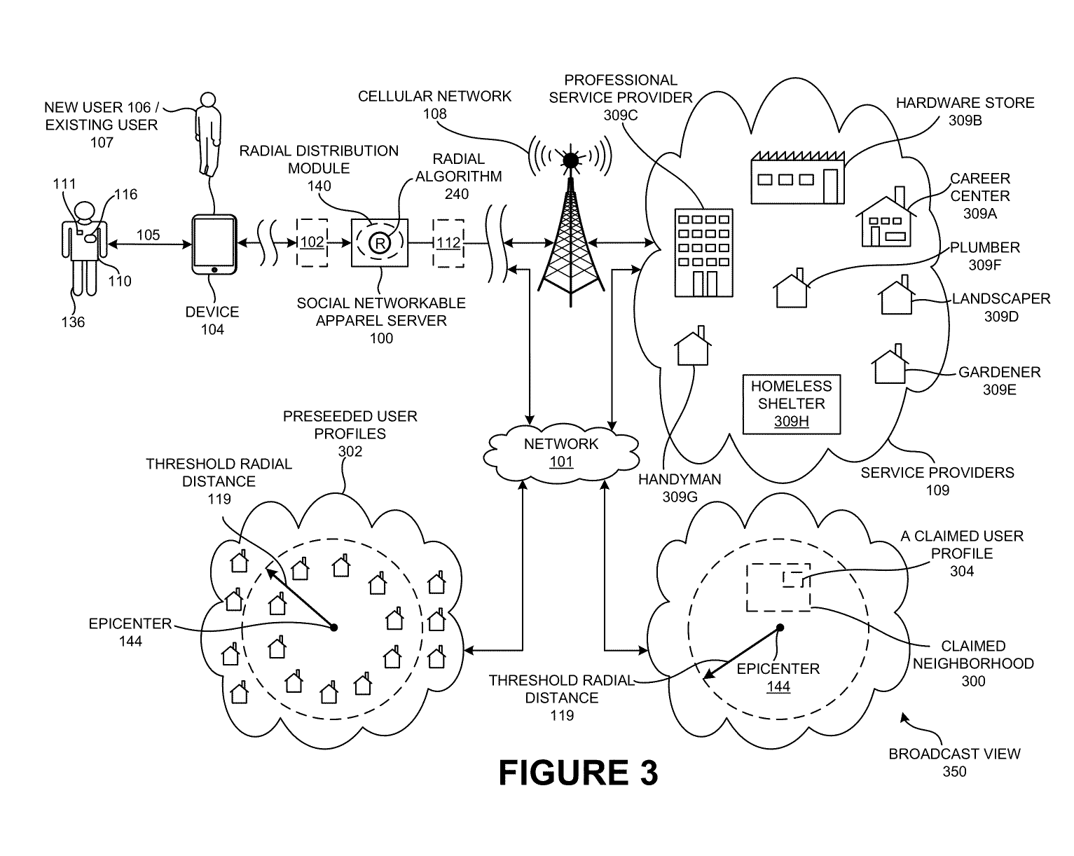

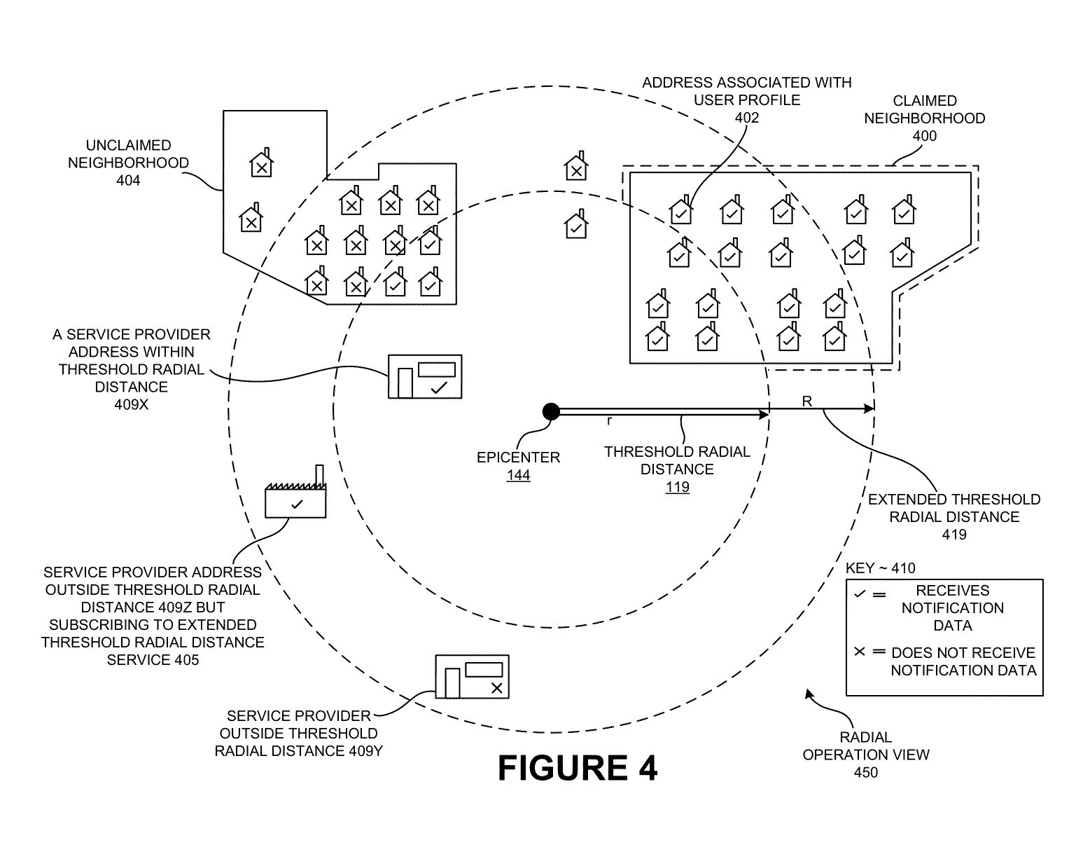

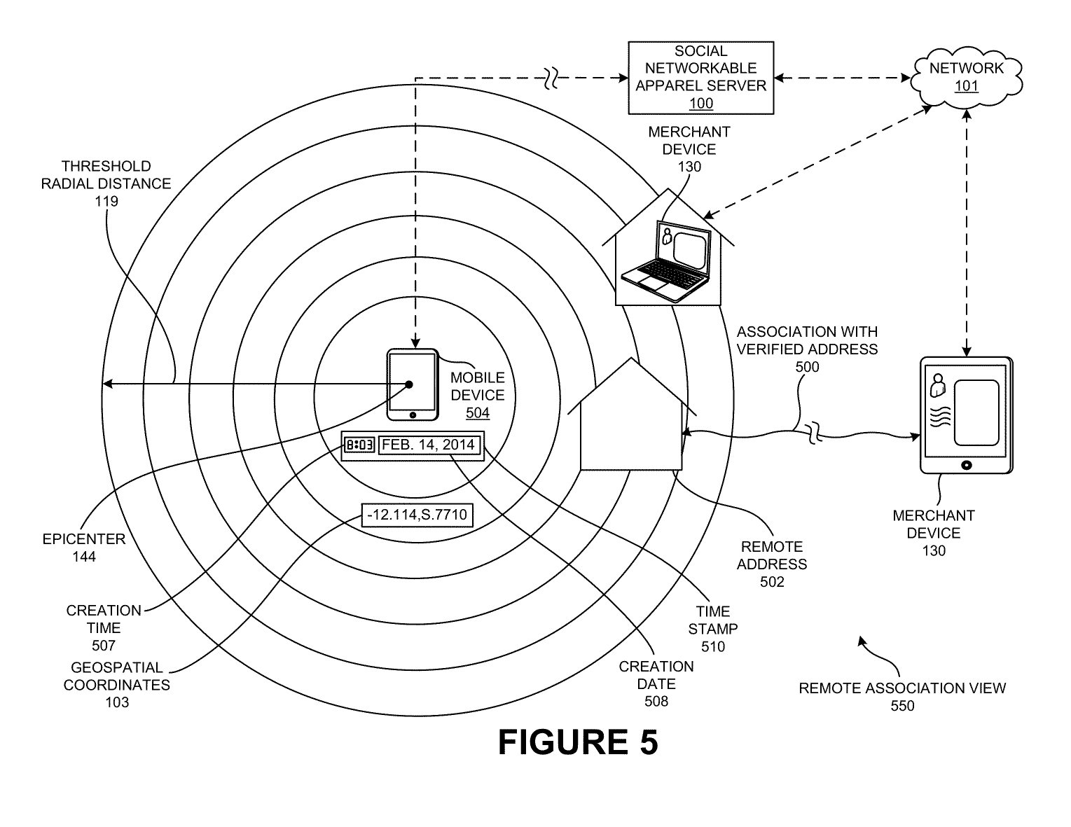

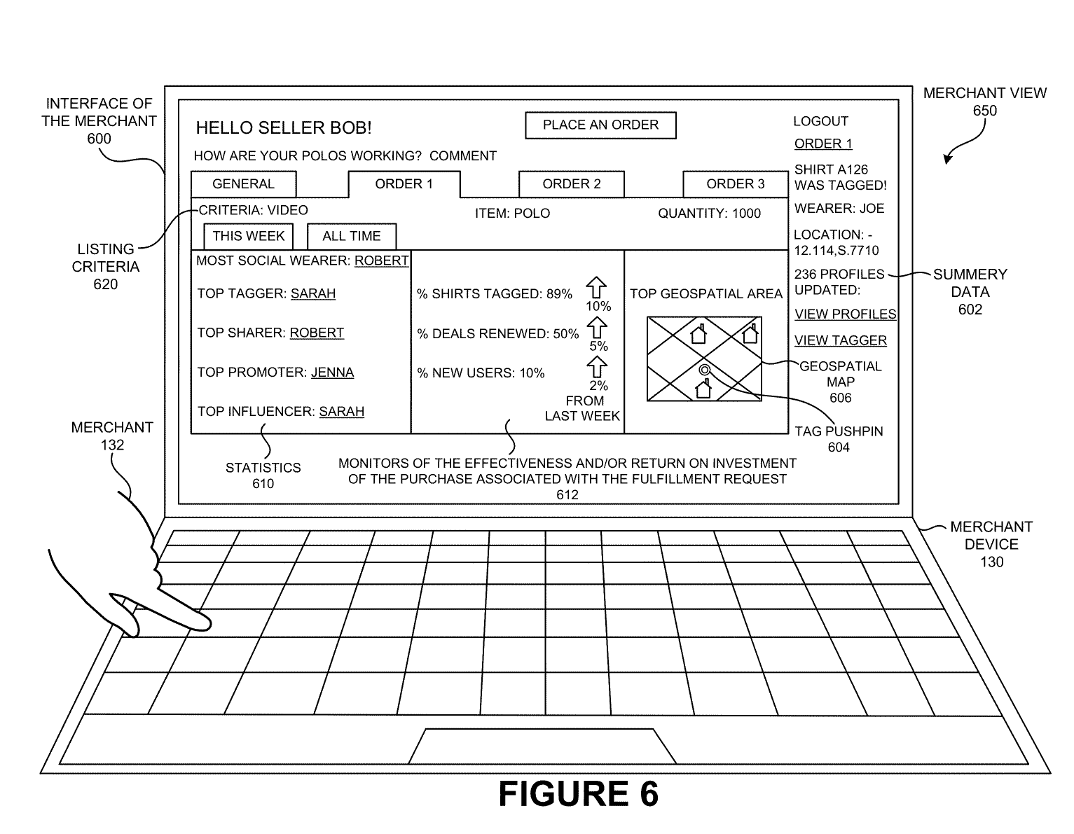

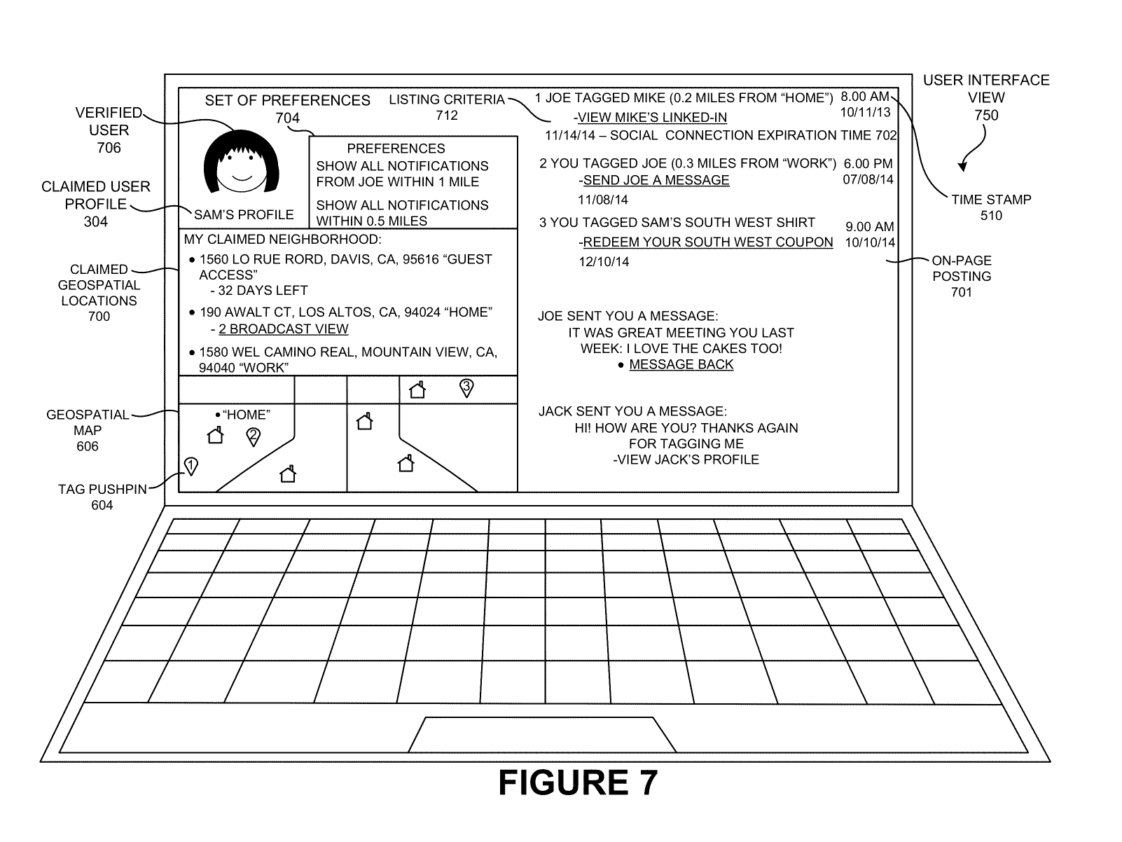

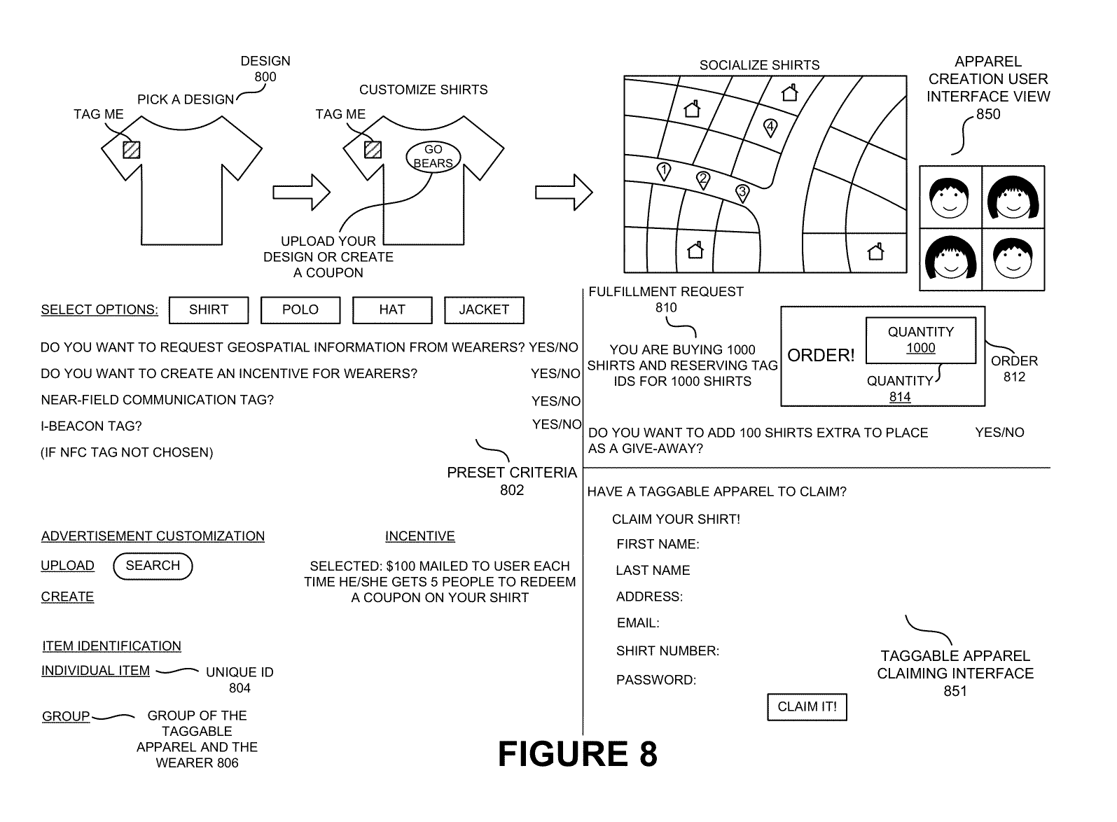

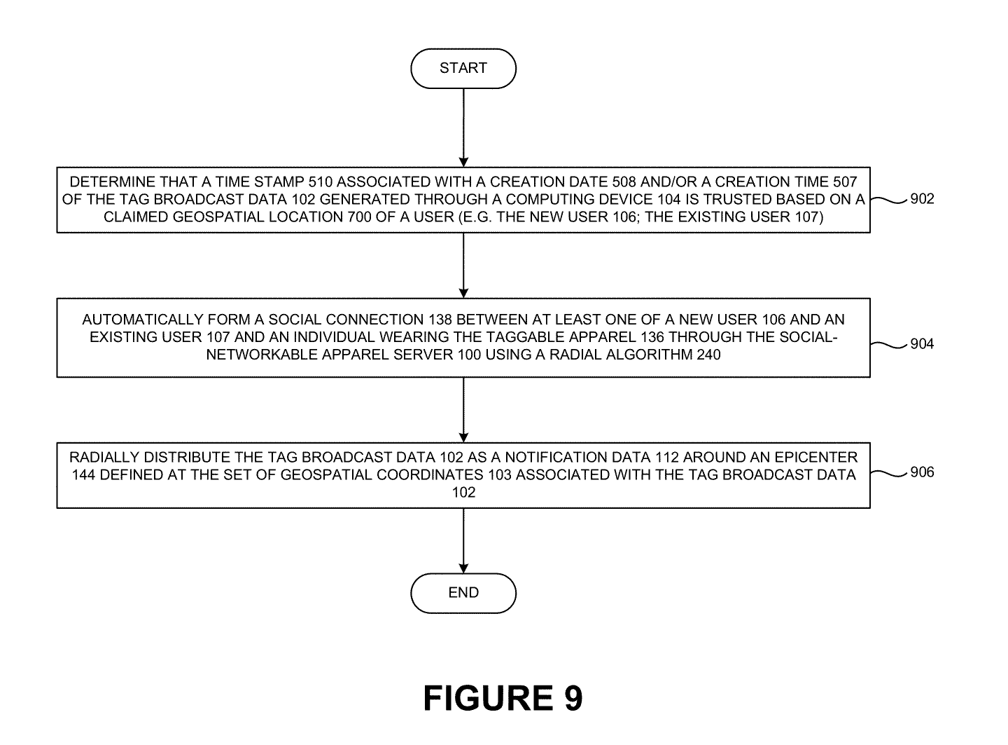

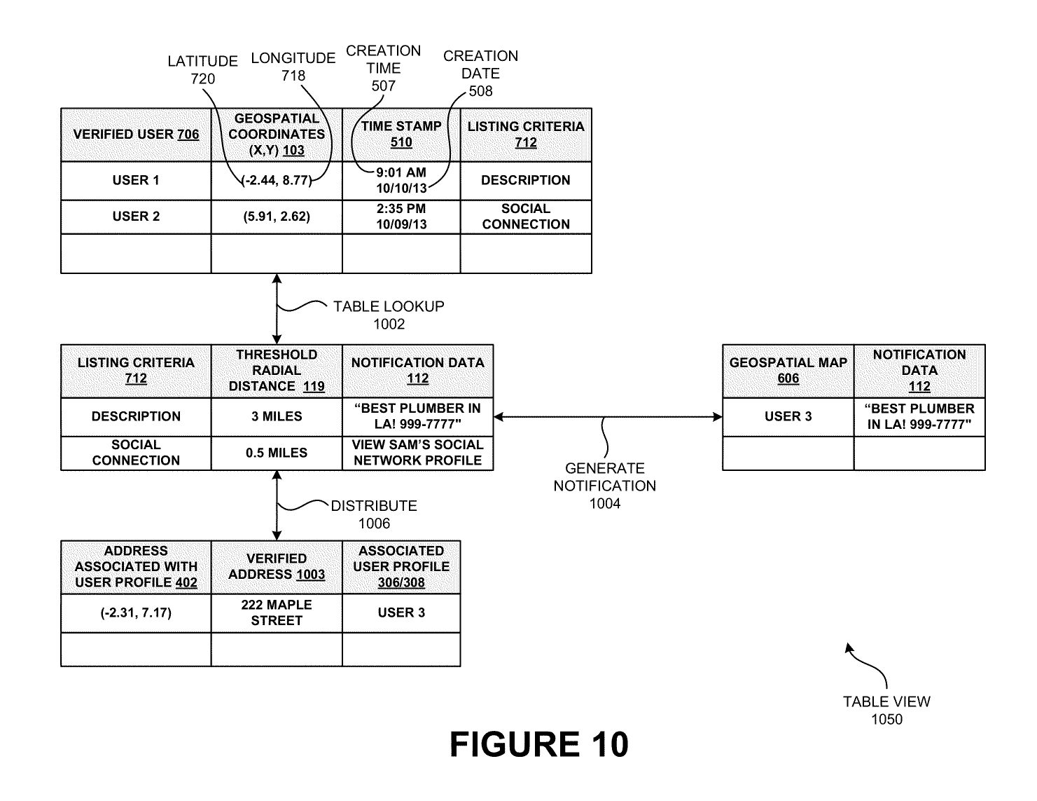

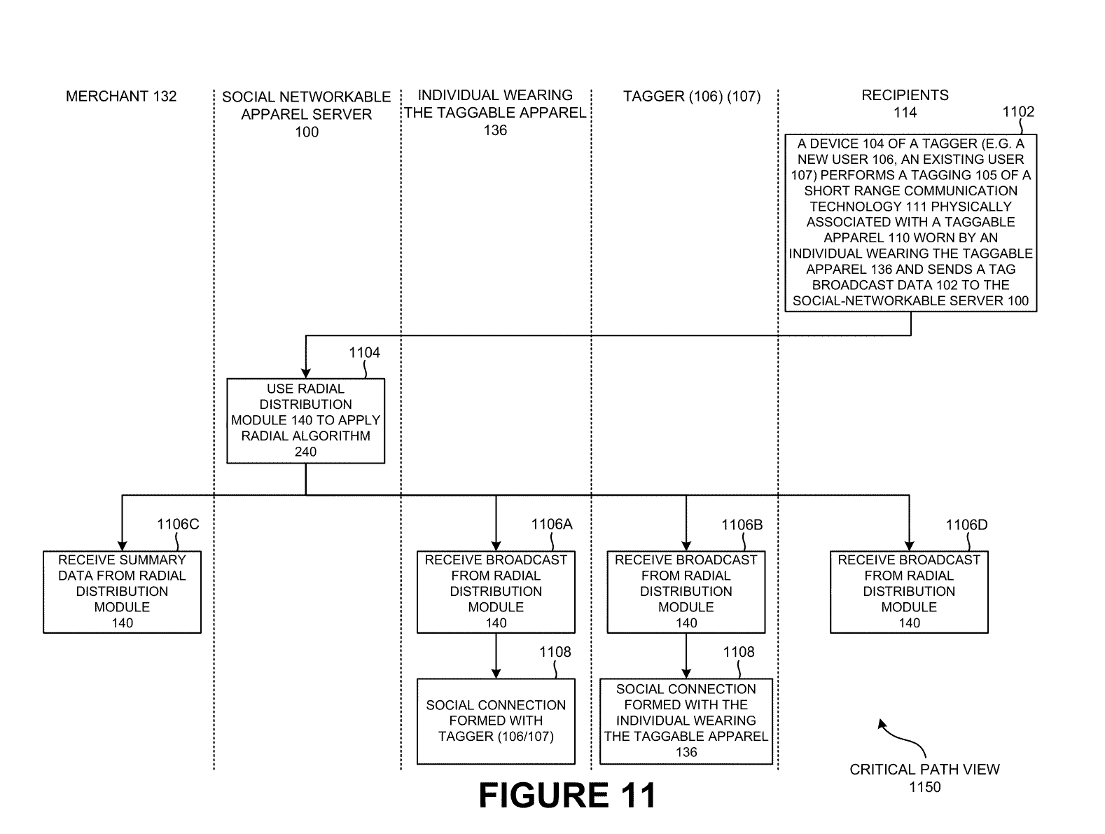

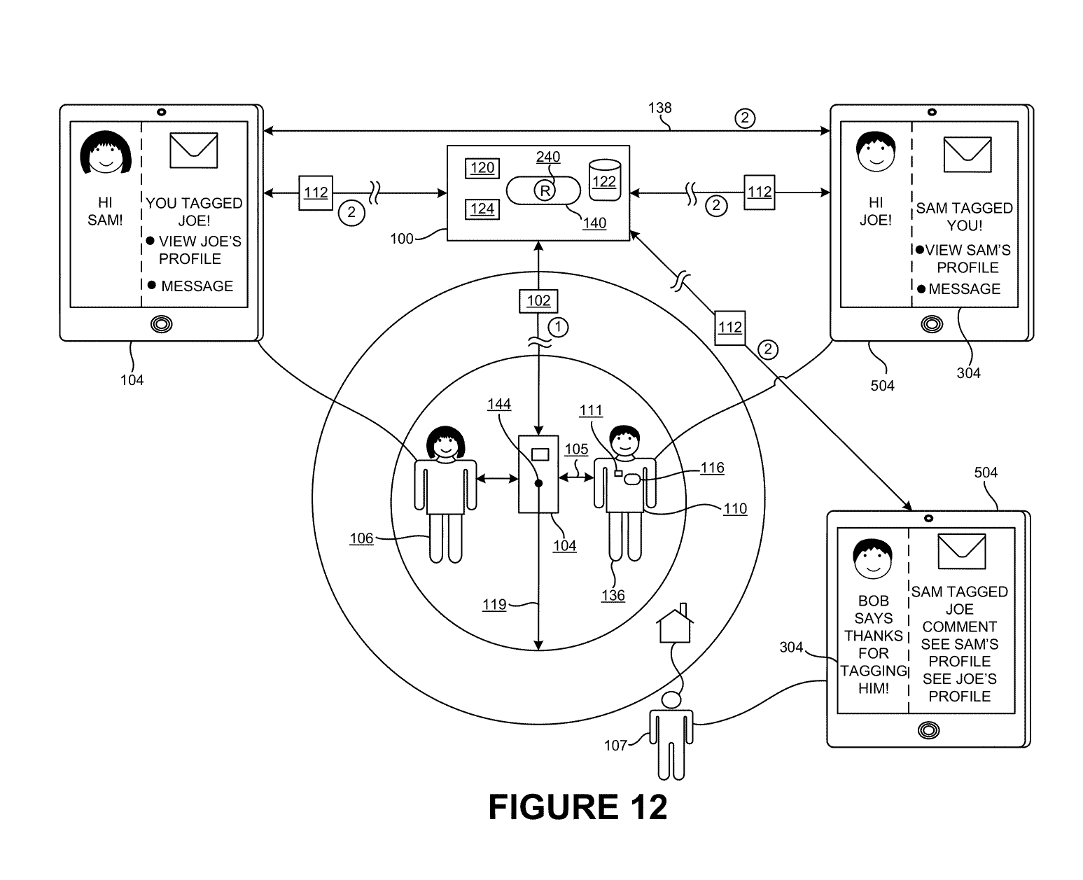

A similar case where the subproblems are only ac1-subgames can also be easily formulated. The main difference is that b(j′) in (Formula 18.1) can be a non solved ae-game and in that case P″(M(i),b(j′)) is the given payoff of M(i) on the b(j′) ae-game. In FIG. 7 where the k=3, 2, 1, 0 subproblems are shown in case the method has only ac1-subgames as subproblems, one can see this difference comparing FIG. 7 to FIGS. 5 and 6.

One can obtain different recursion methods that use ac1-subgames and ae-games as subproblems by introducing other functions instead of the one shown in (Formula 18.1). For example one can use the more general formula

$$P ( M ( i ) , k , 1 ( k ) ) == F ( k , 1 ( k ) ; P ( M ( i ) , a ( 2 , 5 ) ) ; {P}^{″} ( M ( i ) , b ( {j}^{′} ) ) , {j}^{′} in {J}^{′} ) \qquad ( Formula 18.2 )$$

to calculate the payoff in a subproblem that is related to a ac1(a(k,l(k)))-subgame, where F is a function that depends on (k,l(k)) and the rest of the quantities in (Formula 18.2) have their usual meaning and ways to obtain them.

1. I claim a method called ac-games, said method is a generalization of the theory of differential games, said method can be applied in cases where more than two players take part in a differential game and these players can form and change coalitions, said method comprises of:
a set called set of all players and all its subsets, and
a set called set of all ac-games;
wherein a ac-game comprises of:
a set N called set of players that take part in the ac-game,
a partition of N into disjoint subsets Mi none of which is the vacuum set, said partition is called set of c-coalitions in the ac-game and each subset Mi that belongs in the partition is called a c-coalition, wherein i takes all values in a set ID={1, 2, . . . , maxID} wherein maxID is an ordinal,
an element called algebraic ac-game,
a set VAR called set of variables in the ac-game,
a domain wherein the elements of the set VAR take values and a set of subsets DCT(j) of the domain DCT wherein c-times take values,
a family of non vacuum subsets VARS(Mi) of VAR,
wherein for each c-coalition Mi in the set of c-coalitions in the ac-game there exists one and only one subset VARS(Mi) of VAR, said subset VARS(Mi) is called set of variables controlled by the c-coalition Mi, and
wherein VAR=∪VARS(Mi) wherein the union is over all c-coalitions Mi,
a family of functions P(Mi),
wherein i takes all values in the set ID,
wherein for each Mi there exists one and only one function P(Mi),
wherein each P(Mi) depends on a set VARP(Mi) of variables,
wherein VARP(Mi) is a subset of VAR, and
wherein VAR=∪VARP(Mi) wherein the union is over all i in ID, and
wherein each P(Mi) is called payoff of the c-coalition Mi in the ac-game, and
an axiom;
wherein an algebraic ac-game comprises of:
elements called ae-games,
an ordered tree structure, and
elements called realizations;
wherein an ae-game, denoted by a, is either an e-game or a ne-game or a se-game,
wherein an e-game a comprises of:
a set R(a) that consists of two elements, said R(a) can be the set {1, 2},
the subsets Nr(a) of N for all values of r in R(a),
wherein N1(a) is different from the vacuum set and is called set of maximizers in the e-game a, and
wherein N2(a) is different from the vacuum set and furthermore N1(a) and N2(a) have no elements in common, said subset N2(a) is called set of minimizers in the e-game,
the set of players N(a) that take part in the e-game a, said set is defined to be the union N1(a)∪N2(a),
a set ADN(a) called set of players in the e-game a that control additional variables, said ADN(a) is a subset of N1(a)∪N2(a),
a set NIN(a) called set of players in the e-game a that control non-Isaacs variables, said NIN(a) is a subset of N1(a)∪N2(a), and
a differential game as formulated by Isaacs and others, said game contains:
two sets of functions
Φ(t)={φ1(t), . . . , φp(t)}
and
Ψ(t)={ψ1(t), . . . , ψq(t)}
and their union called set of control function variables of the differential game,
a payoff function
$$P ( Φ ( t ) , Ψ ( t ) ) == \int ( G ( X ( t ) , Φ ( t ) , Ψ ( y ) ) ) d t + H$$
called the Isaac's payoff,
a method used to obtain optimal values for the control function variables, said method is called Isaacs solution concept and is written in the symbolic language of game theory as
max min P( Φ(t), Ψ(t) ) , and
Ψ(t) Φ(t)
the value function defined by
V = max min P( Φ(t), Ψ(t) ) ,
Ψ(t) Φ(t)
wherein a se-game a comprises of:
a set R(a), said set is an one element set {r} and it can be the set {1},
the set of players N(a) that take part in the se-game a, said set is defined to be Nr(a),
a set ADN(a) called set of players in the se-game a that control additional variables, said ADN(a) is a subset of N(a),
a set NON(a) called set of players in the se-game a that control non-optimization variables, said NON(a) is a subset of N(a), and
an optimization problem that contains:
a sets of functions
Φ(t)={φ1(t), . . . , φp(t)}
called set of control function variables of the optimization problem,
a payoff function
P(Φ(t))=∫(G(X(t),Φ(t)))dt+H,
a method used to obtain optimal values Φ*(t) for the control function variables, said is written in the symbolic language of control theory as
max P( Φ(t) ) , and
Φ(t)
the value function defined by
V = max P( Φ(t) ) , and
Φ(t)
wherein a ne-game a comprises of:
a set R(a), said set R(a) can be an interval of the ordinals {1, 2, . . . , maxR(a)} wherein maxR(a) is an ordinal that depends on a and is equal to or larger than 2,
a family of subsets Nr(a) of the set N,
wherein r takes all values in R(a),
wherein Nr(a) is different from the vacuum set for any r in R(a), and
wherein the sets Nr(a) and Nr′(a) have no elements in common for any r and r′ in R(a) such that r is different from r′,
the set of players that take part in the ne-game a, said set is defined to be the union N(a)=∪Nr(a) wherein the union is over all r in R(a),
a set ADN(a) called set of players in the ne-game a that control additional variables, said ADN(a) is a subset of N(a),
a set NNN(a) called set of players in the ne-game a that control non-Nash variables, said NNN(a) is a subset of N(a), and
a many player differential game, as can be found in Friedman and elsewhere, said game contains:
a family of sets of functions
Φr(t)={φr1(t), . . . , φrp(r)(t)},
wherein r takes all values in R(a),
wherein p(r) is an ordinal that depends on r, and
wherein their union is called set of control function variables of the differential game,
a family of payoff functions
Pr(Φs(t))=∫(Gr(X(t),Φs(t)))dt+Hr
called the payoffs of the differential game a,
wherein r takes all values in R(a), and
wherein s takes values in R(a),
a method used to obtain optimal values for the control function variables, said method is called Nash equilibrium in Friedman's book and is written here in the symbolic language of game theory as
max Pr( Φs(t) ) , r in R(a), and
Φr(t)
the value functions defined by
Vr = max Pr( Φs(t) ) , r in R(a) ;
Φr(t)
wherein the ordered tree is defined by:
each vertex of the ordered tree is an ae-game in the algebraic ac-game,
each ae-game in the algebraic ac-game is a vertex in the tree, and
the edges are called ac-changes,
wherein each ac-change, denoted by ((a, b)), consists of an ordered pair of ae-games a, b that satisfies the following:
the differential game in the ae-game a is interrupted at time t(a, b), said time is called c-time of the ac-change ((a, b)),
the differential game in the ae-game b begins at time t(a, b), and
the set
{{Nr(a):r in R(a)},{Ns(b):s in R(b)}}
is an ae-coalition change, wherein an ae-coalition change is defined by:
there exists subsets LEAVE(r, a) of Nr(a) for all r in R(a),
there exists subsets CHANGE(r, a; s, b) of Nr(a) for all r in R(a) and all s in R(b),
wherein the intersection of CHANGE(r, a; s, b) and LEAVE(r, a) is the vacuum set for all r in R(a) and all s in R(b), and
wherein the intersection of CHANGE(r, a; s, b) and CHANGE(r, a; s′, b) is the vacuum set for all r in R(a) and all s and s′ in R(b) such that s is different from s′,
there exists subsets JOIN(s, b) of N\N(a) for all s in R(b),
wherein N\N(a) denotes the difference of the sets N and N(a),
and wherein the intersection of JOIN(s, b) and JOIN(s′, b) is the vacuum set for all s and s′ in R(b) such that s is different from s′, and
the set Ns(b) is equal to JOIN(s, b)∪(∪r CHANGE(r, a; s, b)) for all s in R(b), wherein ∪r CHANGE(r, a; s, b) denotes the union of CHANGE(r, a; s, b) over all r in R(a);
wherein the realizations are defined in the following:
there is a unique ae-game a(0) called root of the tree and ae-game of order zero, said ae-game satisfies the property that there is no ac-change ((b, a(0))) in the ordered tree,
there exist at least one ac-change wherein the ae-game a(0) is the first ae-game in the ordered pair in the ac-change,
the set of all ac-changes wherein a(0) is the first ae-game in the ordered pair is called ac1(a(0))-subgame,
an ae-game that is the second element in the ordered pair in a ac-change wherein the first element is the ae-game a(0) is called ae-game of order 1,
if a is an ae-game of order n and the ac-change ((a, b)) exists then the ae-game b is called ae-game of order n+1 wherein n is an ordinal,
an ae-game is called a leaf if there exist no ac-change wherein said ae-game is the first element in the ordered pair,
the set of all ac-changes that contain an ae-game a as first element is called an ac1(a)-subgame,
if the ac-change ((a, b)) exist in the ac1(a)-subgame then the ordered pair (a, b) is called a realization in the ac1(a)-subgame,
a realization A is a sequence of ae-games
(a(0), a(1), . . . , a(n), a(n+1), . . . , a(nmax)),
wherein the first element of this sequence is the root a(0),
wherein the last element a(nmax) is a leaf,
wherein the ae-game a(n) is of order n, and
wherein if a(n) and a(n+1) belong in the realization then there exists an ac-change ((a(n), a(n+1))),
the realizations in a ac-game can be numbered and can be written in the form
A(j)=(a(j,0), a(j,1), . . . , a(j,n), . . . , a(j,n(j))),
wherein the ae-game a(j, n) is of order n, and
wherein n(j) is an ordinal such that the order of any ae-game in the realization is smaller or equal than n(j), said n(j) depends on j wherein j is an ordinal,
an ac-game is said to be in realization form if its realizations are written in the form
A(j)=(a(j,0), a(j,1), . . . , a(j,n(j)))
and the ac-game in realization form can be written as the set {A(j): j in J}
wherein J can be an interval of ordinals {1, 2, . . . , MAXJ}, and
an ac-game is said to be in tree form if its realizations are written in the form
(a(0), a(v(1),1), . . . , a(v(n−1),n−1), a(v(n),n), . . . )
wherein v(n) belongs in an index set V(n, v(n−1)), said index set numbers all ae-games of order n that belong in the ac1(a(v(n−1), n−1)-subgame;
wherein the set VAR consists of:
all elements of the set CT of all c-times, said set is defined to be
CT=∪{t(a,b)},
wherein t(a, b) is the c-time of the ac-change ((a, b)), and
wherein the union is over all ac-changes in the tree in the algebraic ac-game in the ac-game,
all elements of the set ADVAR, said set is called set of all additional variables, said set is defined to be ADVAR=∪ADVAR(a),
wherein the union is over all ae-games a in the algebraic ac-game in the ac-game, and
wherein ADVAR(a) is a set called the set of all additional variables of the ae-game a, said set it is assumed it exists,
all elements of the subset NOVAR, said set is called set of all non-optimization function variables, said set is defined by NOVAR=∪NOVAR(a),
wherein the union is over all se-games a in the algebraic ac-game in the ac-game,
wherein each NOVAR(a) is defined to be a subset of the set of control function variables of the optimization problem in the se-game a,
wherein the elements of each NOVAR(a) are considered as variables and their value needs to be determined along with the other variables in the ac-game, and
wherein the control function variables in the optimization problem in the se-game a that do not belong in NOVAR(a) take the values obtained by solving the optimization problem in the se-game, said values may depend on parameters,
all elements of the set NIVAR, said set is called set of all non-isaacs function variables, said set is defined by NIVAR=∪NIVAR(a),
wherein the union is over all e-games a in the algebraic ac-game in the ac-game,
wherein each NIVAR(a) is defined to be a subset of the set of control function variables of the differential game in the e-game a,
wherein the elements of each NIVAR(a) are considered as variables and their value needs to be determined along with the other variables in the ac-game, and
wherein the control function variables in the differential game in the e-game a that do not belong in NIVAR(a) take the values obtained by solving the differential game in the e-game a using the Isaacs solution concept, said values may depend on parameters, and
all elements of the set NNVAR, said set is called set of all non-Nash function variables, said set is defined by NNVAR=∪NNVAR(a),
wherein the union is over all ne-games a in the algebraic ac-game in the ac-game,
wherein each NNVAR(a) is defined to be a subset of the set of control function variables of the differential game in the ne-game a,
wherein the elements of each NNVAR(a) are considered as variables and their value needs to be determined along with the other variables in the ac-game, and
wherein the control function variables in the differential game in the ne-game a that do not belong in NNVAR(a) take the values obtained by solving the differential game in the ne-game using the Nash equilibrium, said values may depend on parameters;
wherein the domain of the variables in VAR contains the domain DCT in which the c-times take values, said DCT is defined by the inequalities
t(a(j,n),a(j,n+1))<t(a(j,n+1),a(j,n+2)),
for all n such that a(j, n), a(j, n+1)) and a(j, n+2) belong in A(j) and all j in J, and
t0(a(j,n))<t(a(j,n),a(j,n+1))<t1(a(j,n)),
for all n such that a(j, n) and a(j, n+1)) belong in A(j) and all j in J,
wherein t(a(j, n), a(j, n+1)) is the c-time of the ac-change ((a(j, n), a(j, n+1))),
wherein t0(a(j, n)) is the time the differential game in ae-game a(j, n) begins, said time is a c-time if n is larger than 0, and t1(a(j, n)) is the time the differential game in ae-game a(j, n) ends if it is not interrupted,
wherein A(j) is the realization (a(j, 0), a(j, 1), . . . , a(j, n), . . . ),
wherein the ac-game is written in realization form as the set {A(j): j in J}, and
wherein some of the inequality relations can be strict inequality relations and others can be equal or smaller relations and the choice of what type of inequalities will be used depends on the exact mathematical formulation of the solution method of the ac-game and on whether the differential games in all ae-games in a realization will be certainly played or not;
wherein one can define subsets DCT(j) of the domain DCT and construct a one to one onto map between the set of all DCT(j) and the set of all realizations A(j), said subset DCT(j) that corresponds to realization A(j) is defined by the inequalities:
t(a(j,n),a(j,n+1))<t(a(j,n+1),a(j,n+2)),
for all n such that a(j, n), a(j, n+1)) and a(j, n+2) belong in A(j),
t0(a(j,n))<t(a(j,n),a(j,n+1))<t1(a(j,n)),
for all n such that a(j, n) and a(j, n+1)) belong in A(j), and
t(a(j,n),a(j,n+1))<t(a(j,n),a(x(j,n))),
for all n such that a(j, n) and a(j, n+1)) belong in A(j) and all x(j, n) in a set X(j, n),
wherein A(j) is the realization (a(j, 0), a(j, 1), . . . , a(j, n), . . . ),
wherein the c-game is written in realization form as the set {A(j): j in J}, and
wherein a(x(j, n)) is the second ae-game in a realization
A(x(j,n))=(a(j,n),a(x(j,n)))
of the ac1(a(j, n))-subgame with root the ae-game a(j, n)) wherein the index x(j, n) numbers all realizations of the ac1(a(j, n))-subgame except (a(j, n), a(j, n+1));
wherein each VARS(Mi) consists of:
all elements of the subset CT(Mi) of the set CT of all c-times, said subset is called set of c-times controlled by c-coalition Mi, said subset consists of c-times t(a, b) that satisfy:
the union of the sets LEAVE(r, a), CHANGE(r, a; s, b) and JOIN(s, b) has at least one element in common with Mi, wherein the union is over all r in R(a) and all s in R(b),
all elements of the subset ADVAR(Mi) of the set ADVAR, said subset is called the set of additional variables controlled by the c-coalition Mi, said subset consists of additional variables z that satisfy:
if z belongs in ADVAR(Mi) then
there exists an ae-game a in the algebraic ac-game and a subset ADVAR(Mi, a) of the set ADVAR(a) such that z belongs in ADVAR(Mi, a), said ADVAR(Mi, a) is called set of additional variables in ae-game a controlled by c-coalition Mi, and
the set Mi has at least one element in common with ADN(a),
all elements of the subset NOVAR(mi) of the set NOVAR, said subset called the set of non-optimization function variables controlled by c-coalition Mi, said subset consists of non-optimization function variables f that satisfy:
if f belongs in NOVAR(Mi) then
there exists a se-game a in the algebraic ac-game and a subset NOVAR(Mi, a) of the set NOVAR(a) such that f belongs in NOVAR(Mi, a), said NOVAR(Mi, a) is called set of non-optimization function variables in se-game a controlled by c-coalition Mi, and
the set NON(a) has at least one element in common with Mi,
all elements of the subset NIVAR(Mi) of the set NIVAR, said subset called the set of non-isaacs function variables controlled by c-coalition Mi, said subset consists of non-isaacs function variables f that satisfy:
if f belongs in NIVAR(Mi) then
there exists an e-game a in the algebraic ac-game and a subset NIVAR(Mi, a) of the set NIVAR(a) such that f belongs in NIVAR(Mi, a), said NIVAR(Mi, a) is called set of non-isaacs function variables in e-game a controlled by c-coalition Mi, and
the set NIN(a) has at least one element in common with Mi, and
all elements of the subset NNVAR(Mi) of the set NNVAR, said subset called the set of non-Nash function variables controlled by c-coalition Mi, said subset consists of non-Nash function variables f that satisfy:
if f belongs in NNVAR(Mi) then
there exists an ne-game a in the algebraic ac-game and a subset NNVAR(Mi, a) of the set NNVAR(a) such that f belongs in NNVAR(Mi, a), said NNVAR(Mi, a) is called set of non-Nash function variables in ne-game a controlled by c-coalition Mi, and
the set NNN(a) has at least one element in common with Mi; and
wherein the axiom states that in any ac-game, written in realization form as {A(j): j in J}, only the differential games in the ae-games a(j, n) that belong in one and only one realization
A(j)=(a(j,0), a(j,1), . . . , a(j,n), . . . , a(j,n(j)))
will be played and in that case we say the realization A(j) is played or players choose to play realization A(j),
wherein a(j, n(j)) is the ae-game in A(j) that has order n(j) larger than the order of any other ae-game in A(j),
wherein j is one element in the set J wherein J can be chosen to be an interval of ordinals {1, 2, . . . , MAXJ}, and
wherein furthermore:
if t(a(j, 0), a(j, 1)) is larger than t0(a(j, 0))
then
if t(a(j, 0), a(j, 1)) is smaller than t1(a(j, 0))
then
the differential game in ae-game a(j, 0) will be played first from the time t0(a(j, 0)) until the c-time t(a(j, 0), a(j, 1)), wherein t0(a(j, 0)) is the time the differential game in ae-game a(j, 0) begins, and
if t(a(j, 0), a(j, 1)) is equal to t1(a(j, 0))
then
the differential game in ae-game a(j, 0) will be played first from time t0(a(j, 0)) until the time t1(a(j, 0)) when the differential game in ae-game a(j, 0) and the ac-game end, wherein t1(a(j, 0)) is the time the differential game in ae-game a(j, 0) ends,
if t(a(j, 0), a(j, 1)) is equal to t0(a(j, 0))
then the differential game in the root a(j, 0) will not be played,
if t(a(j, n), a(j, n+1)) is different from t(a(j, n+1), a(j, n+2)) for some n smaller than n(j)−1
then the differential game in ae-game a(j, n+1) will be played,
if n is smaller than n(j)−1 and if the differential game in ae-game a(j, n) is played
then
if t(a(j, n), a(j, n+1)) is equal to t1(a(j, n))
then
the differential game in ae-game a(j, n) will be played until the time t1(a(j, n)) when the differential game in ae-game a(j, n) and the ac-game end, wherein t1(a(j, n)) is the time the differential game in ae-game a(j, n) ends, and
if t(a(j, n), a(j, n+1)) is smaller than t1(a(j, n))
then at time t(a(j, n), a(j, n+1)) a ac-change will happen and if t(a(j, n), a(j, n+1)) is different from t(a(j, n+1), a(j, n+2)) then
the differential game in ae-game a(j, n+1) will be played from the time t(a(j, n), a(j, n+1)) until the time t(a(j, n+1), a(j, n+2)) and
if t(a(j, n), a(j, n+1)) is equal to t(a(j, n+1), a(j, n+2))
then
the differential game in ae-game a(j, n+1) will not be played, and
if n is equal to n(j)−1 and if the differential game in ae-game a(j, n(j)−1) is played
then
if t(a(j, n(j)−1), a(j, n(j))) is equal to t1(a(j, n(j)−1))
then
the differential game in ae-game a(j, n(j)−1) will be played until the time t1(a(j, n(j)−1)) when the differential game
in ae-game a(j, n(j)−1) and the ac-game end, wherein t1(a(j, n(j)−1)) is the time the differential game in ae-game a(j, n(j)−1) ends, and
if t(a(j, n(j)−1), a(j, n(j))) is smaller than t1(a(j, n(j)−1))
then
at time t(a(j, n(j)−1), a(j, n(j))) an ac-change will happen and the differential game in ae-game a(j, n(j)) will be played from the time t(a(j, n(j)−1), a(j, n(j))) until the time t1(a(j, n(j))), wherein t1(a(j, n(j))) is the time the differential game in ae-game a(j, n(j)) and the ac-game end.

2. The method of claim 1 wherein furthermore:
for any ac-change ((a, b)) in any ac-game there is at least one s in R(b), thus at least one set of players Ns(b) that is a different set from all sets Nr(a) wherein r belongs in R(a).

3. The method of claim 2 wherein furthermore the set VAR consists only of c-times.

4. I claim a method called recursive solutions of ac-games, said method comprises of:
a set called set of all players and all its subsets,
a set of elements called ac-games, and
a set of elements called mixed type recursive solutions;
wherein a ac-game comprises of:
a set N called set of players that take part in the ac-game,
a partition of N into disjoint subsets Mi none of which is the vacuum set, said partition is called set of c-coalitions in the ac-game and each subset Mi that belongs in the partition is called a c-coalition, wherein i takes all values in a set ID={1, 2, . . . , maxID} wherein maxID is an ordinal,
an element called algebraic ac-game,
a set VAR called set of variables in the ac-game,
a domain wherein the elements of the set VAR take values and a set of subsets DCT(j) of the domain DCT wherein c-times take values,
a family of non vacuum subsets VARS(Mi) of VAR,
wherein for each c-coalition Mi in the set of c-coalitions in the ac-game there exists one and only one subset VARS(Mi) of VAR, said subset VARS(Mi) is called set of variables controlled by the c-coalition Mi, and
wherein VAR=∪VARS(Mi) wherein the union is over all c-coalitions Mi,
a family of functions P(Mi),
wherein i takes all values in the set ID,
wherein for each Mi there exists one and only one function P(Mi),
wherein each P(Mi) depends on a set VARP(Mi) of variables,
wherein VARP(Mi) is a subset of VAR, and
wherein VAR=∪VARP(Mi) wherein the union is over all i in ID, and
wherein each P(Mi) is called payoff of the c-coalition Mi in the ac-game, and
an axiom;
wherein an algebraic ac-game comprises of:
elements called ae-games,
an ordered tree structure, and
elements called realizations;
wherein an ae-game, denoted by a, is either an e-game or a ne-game or a se-game,
wherein an e-game a comprises of:
a set R(a) that consists of two elements, said R(a) can be the set {1, 2},
the subsets Nr(a) of N for all values of r in R(a),
wherein N1(a) is different from the vacuum set and is called set of maximizers in the e-game a, and
wherein N2(a) is different from the vacuum set and furthermore N1(a) and N2(a) have no elements in common, said subset N2(a) is called set of minimizers in the e-game,
the set of players N(a) that take part in the e-game a, said set is defined to be the union N1(a)∪N2(a),
a set ADN(a) called set of players in the e-game a that control additional variables, said ADN(a) is a subset of N1(a)∪N2(a),
a set NIN(a) called set of players in the e-game a that control non-Isaacs variables, said NIN(a) is a subset of N1(a)∪N2(a), and
a differential game as formulated by Isaacs and others, said game contains:
two sets of functions
Φ(t)={φ1(t), . . . , φp(t)}
and
Ψ(t)={ψ1(t), . . . , ψq(t)}
and their union called set of control function variables of the differential game,
a payoff function
$$P ( Φ ( t ) , Ψ ( t ) ) == \int ( G ( X ( t ) , Φ ( t ) , Ψ ( y ) ) ) d t + H$$
called the Isaac's payoff,
a method used to obtain optimal values for the control function variables, said method is called Isaacs solution concept and is written in the symbolic language of game theory as
max min P( Φ(t), Ψ(t) ) , and
Ψ(t) Φ(t)
the value function defined by
V = max min P( Φ(t), Ψ(t) ) ,
Ψ(t) Φ(t)
wherein a se-game a comprises of:
a set R(a), said set is an one element set {r} and it can be the set {1},
the set of players N(a) that take part in the se-game a, said set is defined to be Nr(a),
a set ADN(a) called set of players in the se-game a that control additional variables, said ADN(a) is a subset of N(a),
a set NON(a) called set of players in the se-game a that control non-optimization variables, said NON(a) is a subset of N(a), and
an optimization problem that contains:
a sets of functions
Φ(t)={φ1(t), . . . , φp(t)}
called set of control function variables of the optimization problem,
a payoff function
P(Φ(t))=∫(G(X(t),Φ(t)))dt+H,
a method used to obtain optimal values Φ*(t) for the control function variables, said is written in the symbolic language of control theory as
max P( Φ(t) ) , and
Φ(t)
the value function defined by
V = max P( Φ(t) ) , and
Φ(t)
wherein a ne-game a comprises of:
a set R(a), said set R(a) can be an interval of the ordinals {1, 2, . . . , maxR(a)} wherein maxR(a) is an ordinal that depends on a and is equal to or larger than 2,
a family of subsets Nr(a) of the set N,
wherein r takes all values in R(a),
wherein Nr(a) is different from the vacuum set for any r in R(a), and
wherein the sets Nr(a) and Nr′(a) have no elements in common for any r and r′ in R(a) such that r is different from r′,
the set of players that take part in the ne-game a, said set is defined to be the union N(a)=∪Nr(a) wherein the union is over all r in R(a),
a set ADN(a) called set of players in the ne-game a that control additional variables, said ADN(a) is a subset of N(a),
a set NNN(a) called set of players in the ne-game a that control non-Nash variables, said NNN(a) is a subset of N(a), and
a many player differential game, as can be found in Friedman and elsewhere, said game contains:
a family of sets of functions
Φr(t)={φr1(t), . . . , φrp(r)(t)},
wherein r takes all values in R(a),
wherein p(r) is an ordinal that depends on r, and
wherein their union is called set of control function variables of the differential game,
a family of payoff functions
Pr(Φs(t))=∫(Gr(X(t),Φs(t)))dt+Hr
called the payoffs of the differential game a,
wherein r takes all values in R(a), and
wherein s takes values in R(a),
a method used to obtain optimal values for the control function variables, said method is called Nash equilibrium in Friedman's book and is written here in the symbolic language of game theory as
max Pr( Φs(t) ) , r in R(a), and
Φr(t)
the value functions defined by
Vr = max Pr( Φs(t) ) , r in R(a) ;
Φr(t)
wherein the ordered tree is defined by:
each vertex of the ordered tree is an ae-game in the algebraic ac-game,
each ae-game in the algebraic ac-game is a vertex in the tree, and
the edges are called ac-changes,
wherein each ac-change, denoted by ((a, b)), consists of an ordered pair of ae-games a, b that satisfies the following:
the differential game in the ae-game a is interrupted at time t(a, b), said time is called c-time of the ac-change ((a, b)),
the differential game in the ae-game b begins at time t(a, b), and the set
{{Nr(a):r in R(a)},{Ns(b):s in R(b)}}
is an ae-coalition change, wherein an ae-coalition change is defined by:
there exists subsets LEAVE(r, a) of Nr(a) for all r in R(a),
there exists subsets CHANGE(r, a; s, b) of Nr(a) for all r in R(a) and all s in R(b),
wherein the intersection of CHANGE(r, a; s, b) and LEAVE(r, a) is the vacuum set for all r in R(a) and all s in R(b), and
wherein the intersection of CHANGE(r, a; s, b) and CHANGE(r, a; s′, b) is the vacuum set for all r in R(a) and all s and s′ in R(b) such that s is different from s′,
there exists subsets JOIN(s, b) of N\N(a) for all s in R(b), wherein N\N(a) denotes the difference of the sets N and N(a),
and wherein the intersection of JOIN(s, b) and JOIN(s′, b) is the vacuum set for all s and s′ in R(b) such that s is different from s′, and
the set Ns(b) is equal to JOIN(s, b)∪(∪r CHANGE(r, a; s, b)) for all s in R(b), wherein ∪r CHANGE(r, a; s, b) denotes the union of CHANGE(r, a; s, b) over all r in R(a);
wherein the realizations are defined in the following:
there is a unique ae-game a(0) called root of the tree and ae-game of order zero, said ae-game satisfies the property that there is no ac-change ((b, a(0))) in the ordered tree,
there exist at least one ac-change wherein the ae-game a(0) is the first ae-game in the ordered pair in the ac-change,
the set of all ac-changes wherein a(0) is the first ae-game in the ordered pair is called ac1(a(0))-subgame,
an ae-game that is the second element in the ordered pair in a ac-change wherein the first element is the ae-game a(0) is called ae-game of order 1,
if a is an ae-game of order n and the ac-change ((a, b)) exists then the ae-game b is called ae-game of order n+1 wherein n is an ordinal,
an ae-game is called a leaf if there exist no ac-change wherein said ae-game is the first element in the ordered pair,
the set of all ac-changes that contain an ae-game a as first element is called an ac1(a)-subgame,
if the ac-change ((a, b)) exist in the ac1(a)-subgame then the ordered pair (a, b) is called a realization in the ac1(a)-subgame,
a realization A is a sequence of ae-games
(a(0), a(1), . . . , a(n), a(n+1), . . . , a(nmax)),
wherein the first element of this sequence is the root a(0),
wherein the last element a(nmax) is a leaf,
wherein the ae-game a(n) is of order n, and
wherein if a(n) and a(n+1) belong in the realization then there exists an ac-change ((a(n), a(n+1))),
the realizations in a ac-game can be numbered and can be written in the form
A(j)=(a(j,0), a(j,1), . . . , a(j,n), . . . , a(j,n(j))),
wherein the ae-game a(j, n) is of order n, and
wherein n(j) is an ordinal such that the order of any ae-game in the realization is smaller or equal than n(j), said n(j) depends on j wherein j is an ordinal,
an ac-game is said to be in realization form if its realizations are written in the form
A(j)=(a(j,0), a(j,1), . . . , a(j,n(j)))
and the ac-game in realization form can be written as the set {A(j): j in J} wherein J can be an interval of ordinals {1, 2, . . . , MAXJ}, and
an ac-game is said to be in tree form if its realizations are written in the form
(a(0), a(v(1),1), . . . , a(v(n−1),n−1), a(v(n),n), . . . )
wherein v(n) belongs in an index set V(n, v(n−1)), said index set numbers all ae-games of order n that belong in the ac1(a(v(n−1), n−1)-subgame;
wherein the set VAR consists of:
all elements of the set CT of all c-times, said set is defined to be
CT=∪{t(a,b)},
wherein t(a, b) is the c-time of the ac-change ((a, b)), and
wherein the union is over all ac-changes in the tree in the algebraic ac-game in the ac-game,
all elements of the set ADVAR, said set is called set of all additional variables, said set is defined to be ADVAR=∪ADVAR(a),
wherein the union is over all ae-games a in the algebraic ac-game in the ac-game, and
wherein ADVAR(a) is a set called the set of all additional variables of the ae-game a, said set it is assumed it exists,
all elements of the subset NOVAR, said set is called set of all non-optimization function variables, said set is defined by NOVAR=∪NOVAR(a),
wherein the union is over all se-games a in the algebraic ac-game in the ac-game,
wherein each NOVAR(a) is defined to be a subset of the set of control function variables of the optimization problem in the se-game a,
wherein the elements of each NOVAR(a) are considered as variables and their value needs to be determined along with the other variables in the ac-game, and
wherein the control function variables in the optimization problem in the se-game a that do not belong in NOVAR(a) take the values obtained by solving the optimization problem in the se-game, said values may depend on parameters,
all elements of the set NIVAR, said set is called set of all non-isaacs function variables, said set is defined by NIVAR=∪NIVAR(a),
wherein the union is over all e-games a in the algebraic ac-game in the ac-game,
wherein each NIVAR(a) is defined to be a subset of the set of control function variables of the differential game in the e-game a,
wherein the elements of each NIVAR(a) are considered as variables and their value needs to be determined along with the other variables in the ac-game, and
wherein the control function variables in the differential game in the e-game a that do not belong in NIVAR(a) take the values obtained by solving the differential game in the e-game a using the Isaacs solution concept, said values may depend on parameters, and
all elements of the set NNVAR, said set is called set of all non-Nash function variables, said set is defined by NNVAR=∪NNVAR(a),
wherein the union is over all ne-games a in the algebraic ac-game in the ac-game,
wherein each NNVAR(a) is defined to be a subset of the set of control function variables of the differential game in the ne-game a,
wherein the elements of each NNVAR(a) are considered as variables and their value needs to be determined along with the other variables in the ac-game, and
wherein the control function variables in the differential game in the ne-game a that do not belong in NNVAR(a) take the values obtained by solving the differential game in the ne-game using the Nash equilibrium, said values may depend on parameters;
wherein the domain of the variables in VAR contains the domain DCT in
which the c-times take values, said DCT is defined by the inequalities
t(a(j,n),a(j,n+1))<t(a(j,n+1),a(j,n+2))
for all n such that a(j, n), a(j, n+1)) and a(j, n+2) belong in A(j) and all j in J, and
t0(a(j,n))<t(a(j,n),a(j,n+1))<t1(a(j,n)),
for all n such that a(j, n) and a(j, n+1)) belong in A(j) and all j in J,
wherein t(a(j, n), a(j, n+1)) is the c-time of the ac-change ((a(j, n), a(j, n+1))),
wherein t0(a(j, n)) is the time the differential game in ae-game a(j, n) begins, said time is a c-time if n is larger than 0, and t1(a(j, n)) is the time the differential game in ae-game a(j, n) ends if it is not interrupted,
wherein A(j) is the realization (a(j, 0), a(j, 1), . . . , a(j, n), . . . ),
wherein the ac-game is written in realization form as the set {A(j): j in J}, and
wherein some of the inequality relations can be strict inequality relations and others can be equal or smaller relations and the choice of what type of inequalities will be used depends on the exact mathematical formulation of the solution method of the ac-game and on whether the differential games in all ae-games in a realization will be certainly played or not;
wherein one can define subsets DCT(j) of the domain DCT and construct a one to one onto map between the set of all DCT(j) and the set of all realizations A(j), said subset DCT(j) that corresponds to realization A(j) is defined by the inequalities:
t(a(j,n),a(j,n+1))<t(a(j,n+1),a(j,n+2)),
for all n such that a(j, n), a(j, n+1)) and a(j, n+2) belong in A(j),
t0(a(j,n))<t(a(j,n),a(j,n+1))<t1(a(j,n)),
for all n such that a(j, n) and a(j, n+1)) belong in A(j), and
t(a(j,n),a(j,n+1))<t(a(j,n),a(x(j,n))),
for all n such that a(j, n) and a(j, n+1)) belong in A(j) and all x(j, n) in a set X(j, n),
wherein A(j) is the realization (a(j, 0), a(j, 1), . . . , a(j, n), . . . ),
wherein the c-game is written in realization form as the set {A(j): j in J}, and
wherein a(x(j, n)) is the second ae-game in a realization
A(x(j,n))=(a(j,n),a(x(j,n)))
of the ad (a(j, n))-subgame with root the ae-game a(j, n)) wherein the index x(j, n) numbers all realizations of the ac1(a(j, n))-subgame except (a(j, n), a(j, n+1));
wherein each VARS(Mi) consists of:
all elements of the subset CT(Mi) of the set CT of all c-times, said subset is called set of c-times controlled by c-coalition Mi, said subset consists of c-times t(a, b) that satisfy:
the union of the sets LEAVE(r, a), CHANGE(r, a; s, b) and JOIN(s, b) has at least one element in common with Mi, wherein the union is over all r in R(a) and all s in R(b),
all elements of the subset ADVAR(Mi) of the set ADVAR, said subset is called the set of additional variables controlled by the c-coalition Mi, said subset consists of additional variables z that satisfy:
if z belongs in ADVAR(Mi) then
there exists an ae-game a in the algebraic ac-game and a subset ADVAR(Mi, a) of the set ADVAR(a) such that z belongs in ADVAR(Mi, a), said ADVAR(Mi, a) is called set of additional variables in ae-game a controlled by c-coalition Mi, and
the set Mi has at least one element in common with ADN(a),
all elements of the subset NOVAR(Mi) of the set NOVAR, said subset called the set of non-optimization function variables controlled by c-coalition Mi, said subset consists of non-optimization function variables f that satisfy:
if f belongs in NOVAR(Mi) then
there exists a se-game a in the algebraic ac-game and a subset NOVAR(Mi, a) of the set NOVAR(a) such that f belongs in NOVAR(Mi, a), said NOVAR(Mi, a) is called set of non-optimization function variables in se-game a controlled by c-coalition Mi, and
the set NON(a) has at least one element in common with Mi,
all elements of the subset NIVAR(Mi) of the set NIVAR, said subset called the set of non-isaacs function variables controlled by c-coalition Mi, said subset consists of non-isaacs function variables f that satisfy:
if f belongs in NIVAR(Mi) then
there exists an e-game a in the algebraic ac-game and a subset NIVAR(Mi, a) of the set NIVAR(a) such that f belongs in NIVAR(Mi, a), said NIVAR(Mi, a) is called set of non-isaacs function variables in e-game a controlled by c-coalition Mi, and
the set NIN(a) has at least one element in common with Mi, and
all elements of the subset NNVAR(Mi) of the set NNVAR, said subset called the set of non-Nash function variables controlled by c-coalition Mi, said subset consists of non-Nash function variables f that satisfy:
if f belongs in NNVAR(Mi) then
there exists an ne-game a in the algebraic ac-game and a subset NNVAR(Mi, a) of the set NNVAR(a) such that f belongs in NNVAR(Mi, a), said NNVAR(Mi, a) is called set of non-Nash function variables in ne-game a controlled by c-coalition Mi, and
the set NNN(a) has at least one element in common with Mi;
wherein the axiom states that in any ac-game, written in realization form as {A(j): j in J}, only the differential games in the ae-games a(j, n) that belong in one and only one realization
A(j)=(a(j,0), a(j,1), . . . , a(j,n), . . . , a(j,n(j)))
will be played and in that case we say the realization A(j) is played or players choose to play realization A(j),
wherein a(j, n(j)) is the ae-game in A(j) that has order n(j) larger than the order of any other ae-game in A(j),
wherein j is one element in the set J wherein J can be chosen to be an interval of ordinals {1, 2, . . . , MAXJ}, and
wherein furthermore:
if t(a(j, 0), a(j, 1)) is larger than t0(a(j, 0))
then
if t(a(j, 0), a(j, 1)) is smaller than t1(a(j, 0))
then
the differential game in ae-game a(j, 0) will be played first from the time t0(a(j, 0)) until the c-time t(a(j, 0), a(j, 1)), wherein t0(a(j, 0)) is the time the differential game in ae-game a(j, 0) begins, and
if t(a(j, 0), a(j, 1)) is equal to t1(a(j, 0))
then
the differential game in ae-game a(j, 0) will be played first from time t0(a(j, 0)) until the time t1(a(j, 0)) when the differential game in ae-game a(j, 0) and the ac-game end, wherein t1(a(j, 0)) is the time the differential game in ae-game a(j, 0) ends,
if t(a(j, 0), a(j, 1)) is equal to t0(a(j, 0))
then the differential game in the root a(j, 0) will not be played,
if t(a(j, n), a(j, n+1)) is different from t(a(j, n+1), a(j, n+2)) for some n smaller than n(j)−1
then the differential game in ae-game a(j, n+1) will be played,
if n is smaller than n(j)−1 and if the differential game in ae-game a(j, n) is played
then
if t(a(j, n), a(j, n+1)) is equal to t1(a(j, n))
then
the differential game in ae-game a(j, n) will be played until the time t1(a(j, n)) when the differential game in ae-game a(j, n) and the ac-game end, wherein t1(a(j, n)) is the time the differential game in ae-game a(j, n) ends, and
if t(a(j, n), a(j, n+1)) is smaller than t1(a(j, n))
then at time t(a(j, n), a(j, n+1)) a ac-change will happen and if t(a(j, n), a(j, n+1)) is different from t(a(j, n+1), a(j, n+2))
then
the differential game in ae-game a(j, n+1) will be played from the time t(a(j, n), a(j, n+1)) until the time t(a(j, n+1), a(j, n+2)) and
if t(a(j, n), a(j, n+1)) is equal to t(a(j, n+1), a(j, n+2))
then
the differential game in ae-game a(j, n+1) will not be played, and
if n is equal to n(j)−1 and if the differential game in ae-game a(j, n(j)−1) is played
then
if t(a(j, n(j)−1), a(j, n(j))) is equal to t1(a(j, n(j)−1))
then
the differential game in ae-game a(j, n(j)−1) will be played until the time t1(a(j, n(j)−1)) when the differential game in ae-game a(j, n(j)−1) and the ac-game end, wherein t1(a(j, n(j)−1)) is the time the differential game in ae-game a(j, n(j)−1) ends, and
if t(a(j, n(j)−1), a(j, n(j))) is smaller than t1(a(j, n(j)−1))
then
at time t(a(j, n(j)−1), a(j, n(j))) an ac-change will happen and the differential game in ae-game a(j, n(j)) will be played from the time t(a(j, n(j)−1), a(j, n(j))) until the time t1(a(j, n(j))), wherein t1(a(j, n(j))) is the time the differential game in ae-game a(j, n(j)) and the ac-game end; and
wherein a mixed type recursive solution comprises of:
a particular ac-game,
a particular subset of the set of c-coalitions of the ac-game, said subset consists of elements M(i) wherein the index i takes all values in a set I wherein I contains at least one element,
the sets VARS(M(i)) of variables controlled by the c-coalitions M(i) wherein i takes all values in I,
the payoffs P(M(i)) of the c-coalitions M(i) wherein i takes all values in I,
the set VARS, said set is defined to be the union ∪VARS(M(i)) wherein the union is over all i in I,
a non vacuum index set K, said set can be chosen to be the interval of ordinals {0, 1, . . . , Kmax} wherein Kmax is an ordinal,
a family of sets I(k),
wherein k takes all values in K, and
wherein each I(k) is a non vacuum subset of I,
a family of sets VAR(k),
wherein k takes all values in K,
wherein each VAR(k) is a subset of VARS,
wherein the family of sets VAR(k) is a partition of VARS, and
wherein each VAR(k) satisfies furthermore:
if i belongs in I(k) then VAR(k) contains at least one variable controlled by c-coalition M(i) and
if z′ belongs in VAR(k) then there exists an i′ in I(k) such that the c-coalition M(i′) controls z′,
a family of non vacuum sets L(k),
wherein k takes all values in K, and
wherein the sets L(k′) and L(k″) have no element in common for any k′ and k″ in K such that k′ is different from k″,
a partition of each L(k) into subsets NL(k), GL(k), EL(k), SL(k) and OL(k),
wherein OL(k) is different from L(k) for at least one k in K, and
wherein a partition of an arbitrary set A is a family of subsets A1, A2, . . . of A such that the union of all said subsets is the set A and such that the intersection of any pair of said subsets is the vacuum set whenever both said subsets are different from the vacuum set,
a partition of each SL(k) into subsets SPURL(k) and SMIXL(k),
a partition of each NL(k) into subsets NPURL(k) and NMIXL(k),
a partition of each GL(k) into subsets GPURL(k) and GMIXL(k),
a partition of each EL(k) into subsets EUL(k), ELL(k) and EGL(k),
a partition of each EGL(k) into subsets EGGL(k) and EGNL(k),
a partition of each EGGL(k) into subsets EGGPURL(k) and EGGMIXL(k),
a partition of each EGNL(k) into subsets EGNPURL(k) and EGNMIXL(k),
the subsets PUROL(k) and MIXOL(k) of each OL(k),
the sets PURL(k) wherein each PURL(k) is defined to be the union of SPURL(k), GPURL(k), NPURL(k), EUL(k), ELL(k), EGGPURL(k) and EGNPURL(k), wherein k takes all values in K,
the sets MIXL(k) wherein each MIXL(k) is defined to be the union of SMIXL(k), GMIXL(k), NMIXL(k), EGGMIXL(k) and EGNMIXL(k), wherein k takes all values in K,
a family of sets I(k,l(k)),
wherein k takes all values in K and l(k) takes all values in L(k),
wherein each I(k,l(k)) is a non vacuum subset of I(k), and
wherein each I(k,l(k)) satisfies furthermore:
if SL(k) is not the vacuum set and l(k) belongs in SL(k) then I(k,l(k)) consists of one element,
if GL(k) is not the vacuum set and l(k) belongs in GL(k) then I(k,l(k)) consists of two elements,
if NL(k) is not the vacuum set and l(k) belongs in NL(k) then I(k,l(k)) contains at least two elements,
if EL(k) is not the vacuum set and l(k) belongs in EL(k) then I(k,l(k)) contains at least two elements,
if EGGL(k) is not the vacuum set and l(k) belongs in EGGL(k) then I(k,l(k)) consists of two elements and
if OL(k) is not the vacuum set and l(k) belongs in OL(k) then I(k,l(k)) contains at least one element,
a partition of each VAR(k) into subsets VAR(k,l(k)),
wherein k takes all values in K and l(k) takes all values in L(k),
wherein if EL(k) is not the vacuum set and l(k) belongs in EL(k) then VAR(k,l(k)) consists of c-times,
wherein if MIXL(k) is not the vacuum set and l(k) belongs in MIXL(k) then VAR(k,l(k)) does not contain any element in NIVAR∪NOVAR∪NNVAR, and
wherein each VAR(k,l(k)) satisfies furthermore:
if i belongs in I(k,l(k)) then VAR(k,l(k)) contains at least one variable controlled by c-coalition M(i), and
if z′ belongs in VAR(k,l(k)) then there exists an i′ in I(k,l(k)) such that the c-coalition m(l′) controls z′,
a family of sets VARM(i(k,l(k))),
wherein k takes all values in K, l(k) takes all values in L(k) and (k,l(k)) takes all values in I(k,l(k)),
wherein each VARM(i(k,l(k))) consists of all variables in VAR(k,l(k)) controlled by c-coalition m(i(k,l(k))), and
wherein furthermore the sets VARM(i′(k,l(k))) and VARM(i″(k,l(k))) have no element in common for all k in K and all l(k) in L(k)\(EUL(k)∪ELL(k)) and all i′(k,l(k)) and i″(k,l(k)) in I(k,l(k)) such that i′(k,l(k)) is different from i″(k,l(k)),
a family of probability measures PROBM(i(k,l(k))), said measures are defined only when k and l(k) exist,
wherein k takes all values in K, l(k) takes all values in MIXL(k) and i(k,l(k)) takes all values in I(k,l(k)),
wherein each PROBM(i(k,l(k))) is a measure on all variables in VARM(i(k,l(k))), and
wherein each PROBM(i(k,l(k))) is considered to be a variable that takes values in a space SPACE(k,l(k),i(k,l(k))), said space depends on parameters,
a family of sets of variables, said family consists of:
a family of sets PAYVAR(k,l(k)), said sets are defined only when k and l(k) exist,
wherein k takes all values in K and l(k) takes all values in the union SL(k)∪GL(k), and
wherein each PAYVAR(k,l(k)) is defined to be the set VAR(k,l(k)), and
a family of sets PAYVAR(k,l(k),i(k,l(k))), said sets are defined only when k and l(k) exist,
wherein k takes all values in K, l(k) takes all values in the union EL(k)∪NL(k) and i(k,l(k)) takes all values in I(k,l(k)),
wherein each PAYVAR(k,l(k),i(k,l(k))) is a non vacuum subset of VAR(k,l(k)), and
wherein the union ∪PAYVAR(k,l(k),i(k,l(k))) contains all elements of VAR(k,l(k)) wherein the union is over all (k,l(k)) in I(k,l(k)),
a family of sets of parameters, said family consists of:
a family of sets PAYPAR(k,l(k)), said sets are defined only when k and l(k) exist,
wherein k takes all values in K and l(k) takes all values in the union SL(k)∪GL(k), and
wherein each PAYPAR(k,l(k)) is a subset of the union ∪VAR(k′) wherein the union is over all k′ in {0, 1, . . . , k−1}, and
a family of sets PAYPAR(k,l(k),i(k,l(k))) and the unions PAYPAR(k,l(k))=∪PAYPAR(k,l(k),i(k,l(k))) wherein each union ∪PAYPAR(k,l(k),i(k,l(k))) is over all (k,l(k)) in I(k,l(k)), said sets are defined only when k and l(k) exist,
wherein k takes all values in K, l(k) takes all values in the union EL(k)∪NL(k) and i(k,l(k)) takes all values in I(k,l(k)), and
wherein each PAYPAR(k,l(k),i(k,l(k))) is a subset of the union ∪VAR(k′) wherein the union is over all k′ in {0, 1, . . . , k−1},
a family of sets OPTVARPAR(k,l(k),z(k,l(k))), said sets are defined only when k and l(k) exist,
wherein k takes all values in K and l(k) takes all values in PURL(k) and z(k,l(k)) takes all values in VAR(k,l(k)), and
wherein each OPTVARPAR(k,l(k),z(k,l(k))) is a subset of PAYPAR(k,l(k)),
a family of sets OPTPROBMPAR(k,l(k),i(k,l(k))), said sets are defined only when k and l(k) exist,
wherein k takes all values in K, l(k) takes all values in MIXL(k) and i(k,l(k)) takes all values in I(k,l(k)), and
wherein each OPTPROBMPAR(k,l(k),i(k,l(k))) is a subset of PAYPAR(k,l(k)),
a family of functions OPTVAR(k,l(k),z(k,l(k))), said functions are defined only when k and l(k) exist,
wherein k takes all values in K, l(k) takes all values in PURL(k) and z(k,l(k)) takes all values in VAR(k,l(k)), and
wherein if z belongs in VARS and OPTVAR(k,l(k),z(k,l(k))) depends on z then z belongs in OPTVARPAR(k,l(k),z(k,l(k))),
a family of functions OPTPROBM(k,l(k),i(k,l(k))), said functions are defined only k and l(k) exist,
wherein k takes all values in K, l(k) takes all values in MIXL(k) and i(k,l(k)) takes all values in I(k,l(k)),
wherein if z belongs in VARS and OPTPROBM(k,l(k),i(k,l(k))) depends on z then z belongs in OPTPROBMPAR(k,l(k),i(k,l(k))),
wherein for any value of the variables in OPTPROBMPAR(k,l(k),i(k,l(k))) the value of OPTPROBM(k,l(k),i(k,l(k))) is a probability measure on variables in VARM(i(k,l(k))), and
wherein for any value of the variables in OPTPROBMPAR(k,l(k),i(k,l(k))) the value of OPTPROBM(k,l(k),i(k,l(k))) belongs in the space SPACE(k,l(k),i(k,l(k))), said space depends on the values of the elements in PAYPAR(k,l(k)),
a family of subproblem payoff functions, said family consists of:
a family of functions PAY(k,l(k)), said functions are defined only when k and l(k) exist,
wherein k takes all values in K and l(k) takes all values in the union SL(k)∪GL(k),
wherein PAY(k,l(k)) depends on all variables in VAR(k,l(k)), and
wherein if z belongs in VARS and PAY(k,l(k)) depends on z then z belongs in the union PAYPAR(k,l(k))∪PAYVAR(k,l(k)), and
a family of functions PAY(k,l(k),i(k,l(k))), said functions are defined only when k and l(k) exist,
wherein k takes all values in K, l(k) takes all values in the union EL(k)∪NL(k) and i(k,l(k)) takes all values in I(k,l(k)),
wherein if z belongs in VAR(k,l(k)) then there exists at least one (k,l(k)) in I(k,l(k)) such that PAY(k,l(k),i(k,l(k))) depends on z, and
wherein if z belongs in VARS and PAY(k,l(k),i(k,l(k))) depends on z then z belongs in the union of PAYPAR(k,l(k),i(k,l(k))) and PAYVAR(k,l(k),i(k,l(k))),
a family of sets, said family consists of:
a family of sets OPTPAYPAR(k,l(k)), said sets are defined only when k and l(k) exist,
wherein k takes all values in K and l(k) takes all values in the union SL(k)∪GL(k), and
wherein each OPTPAYPAR(k,l(k)) is a subset of PAYPAR(k,l(k)), and
a family of sets OPTPAYPAR(k,l(k),i(k,l(k))), said sets are defined only when k and l(k) exist,
wherein k takes all values in K, l(k) takes all values in the union EL(k)∪NL(k) and i(k,l(k)) takes all values in I(k,l(k)), and
wherein each OPTPAYPAR(k,l(k),i(k,l(k))) is a subset of PAYPAR(k,l(k)),
a family of functions, said family consists of:
a family of functions OPTPAY(k,l(k)), said functions are defined only when k and l(k) exist,
wherein k takes all values in K and l(k) takes all values in the union SL(k)∪GL(k), and
wherein if z belongs in VARS and OPTPAY(k,l(k)) depends on z then z belongs in OPTPAYPAR(k,l(k)), and
a family of functions OPTPAY(k,l(k),i(k,l(k))), said functions are defined only when k and l(k) exist,
wherein k takes all values in K, l(k) takes all values in the union EL(k)∪NL(k) and i(k,l(k)) takes all values in I(k,l(k)), and
wherein if z belongs in VARS and OPTPAY(k,l(k),i(k,l(k))) depends on z then z belongs in OPTPAYPAR(k,l(k),i(k,l(k))),
the assumption that given any optimization or game or empirical problem, wherein the payoff functions in said problem depend on parameters, the problem can be solved for any values of the parameters in a non vacuum domain, said solutions can be exact or approximate,
the pure solution of optimization or game or empirical problems, said solution comprises of the optimal value of each variable z(k,l(k)) and the optimal value of each payoff,
wherein the payoff functions depend on parameters in PAYPAR(k,l(k)),
wherein said solution can be exact or approximate,
wherein k takes all values in K, l(k) takes all values in PURL(k) and z(k,l(k)) takes all values in VAR(k,l(k)),
wherein for each particular value val(z′) of each variable z′ in PAYPAR(k,l(k)) the optimal value of each variable z(k,l(k)) in VAR(k,l(k)) is defined to be the value of the function OPTVAR(k,l(k),z(k,l(k))) when each variable z′ in OPTVARPAR(k,l(k),z(k,l(k))) takes the value val(z′) whenever z′ in PAYPAR(k,l(k)) belongs also in OPTVARPAR(k,l(k),z(k,l(k))), and in that case we say the optimal value of z(k,l(k)) is the function OPTVARPAR(k,l(k),z(k,l(k))), and
wherein for each particular value val(z′) of each variable z′ in PAYPAR(k,l(k)) the optimal value of a payoff is defined to be the value of said payoff when each variable z(k,l(k)) in VAR(k,l(k)) takes the optimal value, whenever the payoff depends on z(k,l(k)),
wherein furthermore:
if the payoff in the problem is the function PAY (k, l(k))
then
for each particular value val(z′) of each variable z′ in PAYPAR(k,l(k)) the optimal value of PAY(k,l(k)) is equal to the value of OPTPAY(k,l(k)) when each variable z′ in OPTPAYPAR(k,l(k)) takes the value val(z′) whenever z′ in PAYPAR(k,l(k)) belongs also in OPTPAYPAR(k,l(k)), and in that case we say the optimal value of the payoff PAY(k,l(k)) is the function OPTPAY(k,l(k)), and
if the payoffs in the problem are the functions PAY(k,l(k),i(k,l(k)))
then
for each particular value val (z′) of each variable z′ in PAYPAR(k,l(k)) the optimal value of PAY(k,l(k),i(k,l(k)))) is equal to the value of OPTPAY(k,l(k),i(k,l(k))) when each variable z′ in OPTPAYPAR(k,l(k),i(k,l(k))) takes the value val(z′) whenever z′ in PAYPAR(k,l(k)) belongs also in OPTPAYPAR(k,l(k),i(k,l(k)))), for all i(k,l(k))) in I(k,l(k))), and in that case we say the optimal value of the payoff PAY(k,l(k),i(k,l(k))) is the function OPTPAY(k,l(k),i(k,l(k))),
the mixed solution of optimization or game or empirical problems, said solution comprises of the optimal value of each variable PROBM(i(k,l(k))) and the optimal value of each payoff,
wherein the payoff functions depend on parameters in PAYPAR(k,l(k)),
wherein said solution can be exact or approximate,
wherein k takes all values in k, l(k) takes all values in MIXL(k) and i(k,l(k)) takes all values in I(k,l(k)),
wherein for each particular value val(z′) of each variable z′ in PAYPAR(k,l(k)) the optimal value of each PROBM(i(k,l(k))) is defined to be the value of the function OPTPROBM(k,l(k),i(k,l(k))) when each variable z′ in OPTPROBMPAR(k,l(k),i(k,l(k))) takes the value val(z′) whenever z′ in PAYPAR(k,l(k)) belongs also in OPTPROBMPAR(k,l(k),i(k,l(k))), for all i(k,l(k)) in I(k,l(k)), and in that case we say the optimal value of the variable PROBM(k,l(k),i(k,l(k))) is the function OPTPROBM(k,l(k),i(k,l(k))), and
wherein for each particular value val(z′) of each variable z′ in PAYPAR(k,l(k)) the optimal value of a payoff is defined to be the expectation of said payoff with respect to the product of OPTPROBM(k,l(k),i(k,l(k))) wherein the product is over all i(k,l(k)) in I(k,l(k)),
wherein furthermore:
if the payoff in the problem is the function PAY(k,l(k))
then
for each particular value val(z′) of each variable z′ in PAYPAR(k,l(k)) the optimal value of PAY(k,l(k)) is equal to the value of OPTPAY(k,l(k)) when each variable z′ in OPTPAYPAR(k,l(k)) takes the value val(z′) whenever z′ in PAYPAR(k,l(k)) belongs also in OPTPAYPAR(k,l(k)), and in that case we say the optimal value of the payoff PAY(k,l(k)) is the function OPTPAY(k,l(k)), and
if the payoffs in the problem are the functions PAY(k,l(k),i(k,l(k)))
then
for each particular value val(z′) of each variable z′ in PAYPAR(k,l(k)) the optimal value of PAY(k,l(k),i(k,l(k)))) is equal to the value of OPTPAY(k,l(k),i(k,l(k))) when each variable z′ in OPTPAYPAR(k,l(k),i(k,l(k))) takes the value val(z′) whenever z′ in PAYPAR(k,l(k)) belongs also in OPTPAYPAR(k,l(k),i(k,l(k)))), for all i(k,l(k))) in I(k,l(k))), and in that case we say the optimal value of the payoff PAY(k,l(k),i(k,l(k))) is the function OPTPAY(k,l(k),i(k,l(k))),
a family of optimization problems SPURL_PROBLEM(k,l(k)) and their solutions, said problems and solutions are defined only when k and l(k) exist,
wherein k takes all values in K and l(k) takes all values in SPURL(k),
wherein each SPURL_PROBLEM(k,l(k)) can be written, using the symbolic language of optimization theory, as

| | |
|---|---|
| MAX | PAY(k,l(k)) |
| | |
|---|---|
| VARM(i(k,l(k))) | , |

and
wherein the solution of each SPURL_PROBLEM(k,l(k)) comprises of the optimal value OPTVAR(k,l(k),z(k,l(k))) of each variable z(k,l(k)) in VAR(k,l(k)) and the optimal value OPTPAY(k,l(k)) of PAY(k,l(k)),
a family of zero sum game problems GPURL_PROBLEM(k,l(k)) and their solutions, said problems and solutions are defined only when k and l(k) exist,
wherein k takes all values in K and l(k) takes all values in GPURL(k),
wherein each GPURL_PROBLEM(k,l(k)) can be written, using the symbolic language of game theory, as

| | | |
|---|---|---|
| MAX | MIN | PAY(k,l(k)) |

VARM(i(k,l(k))) VARM(ci(k,l(k)))
wherein ci(k,l(k)) denotes the element in I(k,l(k))\{i(k,l(k))}, and
wherein the solution of each GPURL_PROBLEM(k,l(k)) comprises of the optimal value OPTVAR(k,l(k),z(k,l(k))) of each variable z(k,l(k)) in VAR(k,l(k)) and the optimal value OPTPAY(k,l(k)) of PAY(k,l(k)),
a family of game problems NPURL_PROBLEM(k,l(k)) and their solutions, said problems and solutions are defined only when k and l(k) exist,
wherein k takes all values in K and l(k) takes all values in NPURL(k),
wherein each NPURL_PROBLEM(k,l(k)) can be written, using the symbolic language of game theory, as

| | |
|---|---|
| MAX | PAY(k,l(k),i(k,l(k))) , |

VARM(i(k,l(k)))
i(k,l(k)) in I(k,l(k)),
and
wherein the solution, in the form of Nash equilibrium, of each NPURL_PROBLEM(k,l(k)) comprises of the optimal value OPTVAR(k,l(k),z(k,l(k))) of each variable z(k,l(k)) in VAR(k,l(k)) and the optimal value OPTPAY(k,l(k),i(k,l(k))) of PAY(k,l(k),i(k,l(k))) for all i(k,l(k)) in I(k,l(k)),
a family of functionals, said family consists of:
a family of functionals EXPPAY(k,l(k)), said functionals are defined only when k and l(k) exist,
wherein k takes all values in K and l(k) takes all values in the union SMIXL(k)∪GMIXL(k),
wherein each EXPPAY(k,l(k)) is the functional defined by the function PAY(k,l(k))), and
wherein the arguments of the functional are the measures PROBM(i(k,l(k))), and
a family of functionals EXPPAY(k,l(k),i(k,l(k))), said functionals are defined only when k and l(k) exist,
wherein k takes all values in K, l(k) takes all values in NMIXL(k) and i(k,l(k)) takes all values in I(k,l(k)),
wherein each EXPPAY(k,l(k),i(k,l(k))) is the functional defined by the function PAY(k,l(k),i(k,l(k))), and
wherein the arguments of the functional are the measures PROBM(i(k,l(k))),
a family of optimization problems SMIXL_PROBLEM(k,l(k)) and their solutions, said problems and solutions are defined only when k and l(k) exist,
wherein k takes values in K and l(k) takes all values in SMIXL(k),
wherein each SMIXL_PROBLEM(k,l(k)) can be written, using the symbolic language of optimization theory, as

| | |
|---|---|
| MAX | EXPPAY(k,l(k)), |

PROBM(i(k,l(k)))
,
and
wherein the solution of each SMIXL_PROBLEM(k,l(k)) comprises of the optimal value OPTPROBM(k,l(k),i(k,l(k))) of the variable PROBM(k,l(k),i(k,l(k))) and the optimal value OPTPAY(k,l(k)) of PAY(k,l(k)), wherein i(k,l(k)) takes all values in I(k,l(k)),
a family of zero sum game problems GMIXL_PROBLEM(k,l(k)) and their solutions, said problems and solutions are defined only when k and l(k) exist,
wherein k takes all values in K and l(k) takes all values in GMIXL(k),
wherein each GMIXL_PROBLEM(k,l(k)) can be written, using the symbolic language of game theory, as

| | | |
|---|---|---|
| MAX | MIN | EXPPAY(k,l(k)) |

PROBM(i(k,l(k))) PROBM(ci(k,l(k)))
wherein ci(k,l(k)) denotes the element in I(k,l(k))\{i(k,l(k))}, and
wherein the solution of each GMIXL_PROBLEM(k,l(k)) comprises of the optimal value OPTPROBM(k,l(k),i(k,l(k))) of each variable PROBM(k,l(k),i(k,l(k))) and the optimal value OPTPAY(k,l(k)) of PAY(k,l(k)), wherein i(k,l(k)) takes all values in I(k,l(k)),
a family of game problems NMIXL_PROBLEM(k,l(k)) and their solutions, said problems and solutions are defined only when k and l(k) exist,
wherein k takes all values in K and l(k) takes all values in NMIXL(k),
wherein each NMIXL_PROBLEM(k,l(k)) can be written, using the symbolic language of game theory, as

| | |
|---|---|
| MAX | EXPPAY(k,l(k),i(k,l(k))) , |

PROBM(i(k,l(k)))
i(k,l(k)) in I(k,l(k)),
and
wherein the solution, in the form of Nash equilibrium, of each NMIXL_PROBLEM(k,l(k)) comprises of the optimal value OPTPROBM(k,l(k),i′(k,l(k))) of each variable PROBM(k,l(k),i′(k,l(k))) and the optimal value OPTPAY(k,l(k),i(k,l(k))) of each PAY(k,l(k),i(k,l(k))), wherein i′(k,l(k)) and i(k,l(k)) take all values in I(k,l(k)),
a family of elements ELL_PROBLEM(k,l(k)) called lower empirical problems and their solutions called lower empirical solutions, said elements ELL_PROBLEM(k,l(k)) are defined only when k and l(k) exist,
wherein k takes all values in K and l(k) takes all values in ELL(k), and
wherein each ELL_PROBLEM(k,l(k)) and its solution comprise of:
a ac-game such that the algebraic ac-game in the ac-game consists of ae-games of order smaller or equal to 1, said ac-game can be written in realization form as
{A(k,l(k),j(k,l(k))):j(k,l(k)) in J(k,l(k))},
wherein J(k,l(k)) can be chosen to be the interval of ordinals {1, 2, . . . , Jmax(k,l(k))} wherein Jmax(k,l(k)) is an ordinal larger than 1, and
wherein each realization can be given by
$$A ( k , 1 ( k ) , j ( k , 1 ( k ) ) ) == ( a 0 ( k , 1 ( k ) ) , a 1 ( k , 1 ( k ) , j ( k , 1 ( k ) ) ) )$$
wherein a0(k,l(k)) is the first ae-game and a1(k,l(k),j(k,l(k))) is the second ae-game in the realization,
the set of c-times T(j(k,l(k)))==t(a0(k,l(k)), a1(k,l(k),j(k,l(k)))),
wherein for each value j(k,l(k)) in J(k,l(k)) there exists a c-time T(j(k,l(k))), and
wherein said set of c-times is VAR(k,l(k)),
the vector c-time variable T(k,l(k))==(T(1), T(2), . . . , T(Jmax(k,l(k)))
that takes values in the cube CUBE (k,l(k))==X[to(a0(k,l(k))), t1(a0(k,l(k)))],
wherein T(j′) is the c-time T(j(k,l(k))) when j(k,l(k)) takes the value j′ in J(k,l(k)),
wherein t0(a0(k,l(k))) is the time the differential game in ae-game a0(k,l(k)) begins and t1(a0(k,l(k))) the time the differential game in ae-game a0(k,l(k)) ends if it is not interrupted,
wherein [to(a0(k,l(k))), t1(a0(k,l(k)))] is the closed time interval that begins at to(a0(k,l(k))) and ends at t1(a0(k,l(k))),
wherein x denotes the cartesian product, and
wherein the dimension of the cube is Jmax(k,l(k)),
a family of subsets J(i(k,l(k))) of J(k,l(k)),
wherein each J(i(k,l(k))) contains at least one element, and
wherein each J(i(k,l(k))) is defined by: j(k,l(k)) belongs in J(i(k,l(k))) if the c-coalition M(i(k,l(k))) controls the c-time T(j(k,l(k))),
a family of subsets I(j(k,l(k))) of I(k,l(k)),
wherein each I(j(k,l(k))) contains at least one element, and
wherein each I(j(k,l(k))) is defined by: i(k,l(k)) belongs in I(j(k,l(k))) if the c-coalition M(i(k,l(k))) controls the c-time T(j(k,l(k))),
a method called main lower empirical solution, said method comprises of the steps:
use the following notation, said notation is introduced to make the formulas shorter,
denote (T(k,l(k))) by (T),
denote (CUBE(k,l(k))) by (CUBE),
denote (T(j(k,l(k)))) by (T(j)),
denote (i(k,l(k))) by (i),
denote (I(k,l(k))) by (I),
denote (J(i(k,l(k)))) by (J(i)),
denote (PAY(k,l(k),i(k,l(k)))) by (Pi),
denote (to(a0(k,l(k)))) and (t1(a0(k,l(k)))) by (to(a0)) and (t1(a0)) respectively,
denote (Pi) by (Si(j)) if realization j is chosen and j belongs in J(i),
denote (Pi) by (Qi(j)) if realization j is chosen and j belongs in J\J(i),
denote the value of Pi when the c-time vector T takes a particular value and realization j is chosen by (Pi(j,T)),
denote the value of Si(j) when the c-time vector T takes a particular value by (Si(j,T)) and denote the value of Qi(j) when the c-time vector T takes a particular value by (Qi(j,T)),
consider two points (t,i) and (t′,i′) in [to(a0), t1(a0)]×J, wherein [to(a0), t1(a0)]×J denotes the cartesian product of the sets [to(a0), t1(a0)] and J, and define a binary relation called LOWBETTER by:
(t,j) is LOWBETTER than (t′,j′) if RLOW is true,
wherein RLOW is the logical proposition defined by the propositions:
R1=(t<t′),
R21=(there exists T in CUBE),
R22=(there exists T′ in CUBE),
R23=(there exists j in J),
R24=(there exists j′ in J),
R2=R21 [symbol] R22 [symbol] R23 [symbol] R24,
R3=(min T=T(j)) [symbol] (T(j)=t),
R4=(min T′=T′(j′)) [symbol] (T′(j′)=t′),
R5=(Si(j,T)≧Pi(j′,T′), for all i in I(j)),
R61=(there exists j″ in J),
R62=(there exists T″ in CUBE),
R63=(min T″=T″(j″)) [symbol] (T″(j″)=t),
R6=R61 [symbol] R62 [symbol] R63,
R7=(i(j)∩I(j″)=Ø),
R8=(Qi(j,T)≧Pi(j′,T′) for all i in I(j″)),
R9=(Si(j,T)>Qi(j″,T″), for all i in I(j)),
R101=(there exists j′″ in J),
R102=(there exists T′″ in CUBE),
R103=(min T′″=T′″(j′″)) [symbol] (T′″(j′″)=t),
R10=R101 [symbol] R102 [symbol] R103,
R11=((I(j)∩I(j′″))≠Ø),
R12=(Si(j,T)≧Pi(j′,T′), for all i in (i(j)∩I(j′″))),
R13=(Qi(j,T)≧Pi(j′,T′), for all i in I(j′″)\(I(j)∩I(j′″))),
R14=(Si(j,T)>Qi(j′″,T′″), for all i in I(j)\(I(j)∩I(j′″))),
R15=R1 [symbol] R2 [symbol] R3 [symbol] R4,
R16=R5,
R17=R6 [symbol] R7 [symbol] R8 [symbol] R9,
R18=R10 [symbol] R11 [symbol] R12 [symbol] R13 [symbol] R14 and
RLOW=R15 [symbol] (R16 [symbol] (R17 [symbol] R18)),
wherein (≠) denotes (not equal to), (≧) denotes (greater than or equal to), (>) denotes (greater than), (Ø) denotes the vacuum set, (∩) is the intersection of two sets symbol, (\) is the difference of two sets symbol, ( [symbol] ) is the logical conjunction symbol and ( [symbol] ) is the logical disjunction symbol,
consider a point (t′,i′) in [to(a0), t1(a0)]×J and define a relation called HASNOLOWBETTER by:
(t′, j′) HASNOLOWBETTER if NOT RLOW is true for all (t,j) that satisfy t<t′,
wherein NOT RLOW is the logical negation of logical proposition RLOW,
define KLOW1 to be the subset of [to(a0), t1(a0)]×J that consists of points that satisfy HASNOLOWBETTER and the points in {to(a0)}×J and define TEL1 to be the point in [to(a0), t1(a0)] that satisfies
TEL1 = sup KLOW1
t
wherein
sup KLOW1
t
denotes the supremum of the set of all t in [to(a0), t1(a0)] such that (t,j) is in KLOW1,
define KLOW1′ to be the subset of KLOW1 that satisfies:
(t,j) belongs in KLOW1′
if there exists (t″″, j″″) in KLOW1 such that t=t″″ and j≠j″″,
define the set KLOW2 by KLOW2=KLOW1\KLOW1′, and
define the main lower empirical solution ELS=(TEL,j(TEL)) that consists of the point TEL in KLOW2 and the realization index j(TEL) that corresponds to TEL, wherein TEL is defined by
TEL = sup KLOW2
t
wherein
sup KLOW2
t
denotes the supremum of the set of all t in [to(a0), t1(a0)] such that (t,j) is in KLOW2, and
wherein ELS exists and is unique if KLOW2 is non vacuum and the set of all t such that (t,j) belongs in KLOW2 is closed from the right,
methods that are simple variations of the method called main lower empirical solution,
wherein a simple variation is
either the replacement of the larger or equal inequality by strict inequality or the replacement of the strict inequality by larger or equal inequality in one or more of R1, R5, R8, R9, R12, R13 and R14
or the restriction of the domain of c-times to a non vacuum subset of the closed interval [to(a0), t1(a0)] or both, and
wherein said simple variations can be used to obtain ELS and TEL1 as in the method called main lower empirical solution, and
the application of either the method called main lower empirical solution or one of its simple variations to the problem ELL_PROBLEM(k,l(k)),
wherein the solution ELS=(TEL,j(TEL)) is written as
ELS(k,l(k))=(TEL(k,l(k)),j(TEL)(k,l(k)))
and the point TEL1 is written as TEL1(k,l(k)), said solution and point depend on the values val(z′) of the variables z′ in PAYPAR(k,l(k)),
wherein there exist a function ELL_ASIGNVAR(k,l(k)), said function depends on the values val(z′) of the variables z′ in PAYPAR(k,l(k)), said function assigns to each c-time variable T(j(k,l(k))) an optimal value OPTLOWT(j(k,l(k))), said optimal value depends on the values val(z′) of the variables z′ in PAYPAR(k,l(k)),
wherein OPTLOWT(j(k,l(k))) is defined to be the time TEL(k,l(k)) if j(k,l(k)) equals j(TEL)(k,l(k)), and
wherein OPTLOWT(j(k,l(k))) is defined to be a value larger than TEL(k,l(k)) if j(k,l(k)) is different from j(TEL)(k,l(k)),
wherein whenever z(k,l(k)) is the c-time T(j(k,l(k))) OPTLOWT(j(k,l(k))) is defined to be OPTVAR(k,l(k),z(k,l(k))), and
wherein the optimal value of PAY(k,l(k),i(k,l(k))) is OPTPAY(k,l(k),i(k,l(k))),
a family of elements EUL_PROBLEM(k,l(k)) called upper empirical type problems and their solutions called upper empirical solutions, said elements EUL_PROBLEM(k,l(k)) are defined only when k and l(k) exist,
wherein k takes all values in K and l(k) takes all values in EUL(k), and
wherein each EUL_PROBLEM(k,l(k)) and its solution comprise of:
a ac-game defined as in the case of lower empirical solution,
the set of c-times T(j(k,l(k))) defined as in the case of lower empirical solution,
the vector c-time variable T(k,l(k)) defined as in the case of lower empirical solution,
a family of subsets J(i(k,l(k))) of J(k,l(k)) defined as in the case of lower empirical solution,
a family of subsets I(j(k,l(k))) of I(k,l(k)) defined as in the case of lower empirical solution,
a method called main upper empirical solution, said method comprises of the steps:
use the notation introduced in the case of the lower empirical solution,
consider two points (t,i) and (t′,i′) in [to(a0), t1(a0)]×J,
wherein [to(a0), t1(a0)]×J denotes the cartesian product of the sets [to(a0), t1(a0)] and J, and define a binary relation called UPBETTER by (t,j) is UPBETTER than (t′,j′) if RUP is true,
wherein RUP is the logical proposition defined by RUP=R1 [symbol] R2 [symbol] R3 [symbol] R4 [symbol] R5 wherein R1, R2, R3, R4, and R5 are the logical propositions defined in the case of the lower empirical solution,
consider a point (t′,i′) in [to(a0), t1(a0)]×J and define a relation called HASNOUPBETTER by (t′, j′) HASNOUPBETTER if NOT RUP is true for all (t,j) that satisfy t<t′,
wherein NOT RUP is the logical negation of logical proposition RUP,
define KUP1 to be the subset of [to(a0), t1(a0)]×J that consists of points that satisfy HASNOUPBETTER and the points in {to(a0)}×J
and define TEU1 to be the point in [to(a0), t1(a0)] that satisfies
TEU1 = sup KUP1
t
wherein
sup KUP1
t
denotes the supremum of the set of all t in [to(a0), t1(a0)] such that (t,j) is in KUP1,
define KUP1′ to be the subset of KUP1 that satisfies:
(t,j) belongs in KUP1′
if there exists (t″″, j″″) in KUP1
such that t=t″″ and j≠j″″,
define the set KUP2 by KUP2=KUP1\KUP1′, and
define the main upper empirical solution
EUS=(TEU,j(TEU)) that consists of the point TEU in KUP2 and the realization index j(TEU) that corresponds to TEU,
wherein TEU is defined by
TEU = sup KUP2
t
wherein
sup KUP2
t
denotes the supremum of the set of all t in [to(a0), t1(a0)] such that (t,j) is in KUP2, and
wherein EUS exists and is unique if KUP2 is non vacuum and the set of all t such that (t,j) belongs in KUP2 is closed from the right,
methods that are simple variations of the method called main upper empirical solution,
wherein a simple variation is
either the replacement of the larger or equal inequality by strict inequality or the replacement of the strict inequality by larger or equal inequality in one or more of R1 and R5
or the restriction of the domain of c-times to a non vacuum subset of the closed interval [to(a0), t1(a0)]
or both, and
wherein said simple variation can be used to obtain EUS and TEU1 as in the method called main upper empirical solution, and
the application of either the method called main upper empirical solution or its simple variations to the problem EUL_PROBLEM(k,l(k)),
wherein the solution EUS=(TEU, j(TEU)) is written as
EUS(k,l(k))=(TEU(k,l(k)),j(TEU)(k,l(k)))
and the point TEU1 is written as TEU1(k,l(k)), said solution and point depend on the values val(z′) of the variables z′ in PAYPAR(k,l(k)),
wherein there exists a function EUL_ASIGNVAR(k,l(k)), said function depends on the values val(z′) of the variables z′, said function assigns to each c-time variable T(j(k,l(k))) an optimal value OPTUPT(j(k,l(k))), said optimal value depends on the values val(z′) of the variables z′,
wherein OPTUPT(j(k,l(k))) is defined to be the time TEU(k,l(k)) if j(k,l(k)) equals j(TEU)(k,l(k)), and
wherein OPTUPT(j(k,l(k))) is defined to be a value larger than TEU(k,l(k)) if j(k,l(k)) is different from j(TEU)(k,l(k)),
wherein whenever z(k,l(k)) is the c-time T(j(k,l(k))) OPTUPT(j(k,l(k))) is defined to be OPTVAR(k,l(k),z(k,l(k))), and
wherein the optimal value of PAY(k,l(k),i(k,l(k))) is OPTPAY(k,l(k),i(k,l(k))),
a family of elements EGGPURL_PROBLEM(k,l(k)) called empirical game type pure problems and their solutions called empirical game type pure solutions, said elements are defined only when k and l(k) exist,
wherein k takes all values in K and l(k) takes all values in EGGPURL(k), and
wherein each EGGPURL_PROBLEM(k,l(k)) comprises of:
a set GAME_INFO(k,l(k)), said set is introduced to simplify the presentation of empirical game problems, said set comprises of:
a ac-game and the c-time variables as in the case of lower empirical solution,
the functions PAY(k,l(k),i(k,l(k))) for all values of i(k,l(k)) in I(k,l(k)),
an upper empirical problem with payoffs PAY(k,l(k),i(k,l(k))), its solution EUS(k,l(k)) and the point TEU1(k,l(k)),
a lower empirical problem with payoffs PAY(k,l(k),i(k,l(k))), its solution ELS(k,l(k)) and the point TEL1(k,l(k)), and
for each particular value val(z′) of each variable z′ in PAYPAR(k,l(k)) the times T0(k,l(k)) and T1(k,l(k)),
wherein T0(k,l(k)) can be either TEL(k,l(k)) or TEL1(k,l(k)),
wherein T1(k,l(k)) can be either TEU(k,l(k)) or TEU1(k,l(k)), and
wherein T0(k,l(k)) and T1(k,l(k)) depend on the values val(z′) of the variables z′,
a function EGGPURL_FUN(k,l(k)),
wherein EGGPURL_FUN(k,l(k)) is a function of the functions PAY(k,l(k),i(k,l(k))) wherein i(k,l(k)) takes values in I(k,l(k)), said EGGPURL_FUN(k,l(k)) can be the difference
PAY(k,l(k),i(k,l(k)))−PAY(k,l(k),ci(k,l(k))),
wherein EGGPURL_FUN(k,l(k)) depends on all variables in VAR(k,l(k)), and
wherein if z belongs in VARS\VAR(k,l(k)) and EGGPURL_FUN(k,l(k)) depends on z then z belongs PAYPAR(k,l(k)),
the formulation of a zero sum game problem

| | |
|---|---|
| MAX | MIN EGGPURL_FUN(k,l(k)), |

VARM(i(k,l(k))) VARM(ci(k,l(k)))
wherein ci(k,l(k)) denotes the element in I(k,l(k))\{i(k,l(k))},
wherein the c-times take values in the interval that begins at T0(k,l(k)) and ends at T1(k,l(k)), and
wherein the solution of said game problem exists and the optimal value of each variable z(k,l(k)) in VAR(k,l(k)) is OPTVAR(k,l(k),z(k,l(k))), and
the empirical game type pure solution of EGGPURL_PROBLEM(k,l(k)), said solution is denoted by the prefix (EGPS), said solution comprises of:
the EGPS optimal value of each variable z(k,l(k)) in VAR(k,l(k)), said optimal value is defined to be OPTVAR(k,l(k),z(k,l(k))), and
the EGPS optimal value of each PAY(k,l(k),i(k,l(k))), said EGPS optimal value is the value of PAY(k,l(k),i(k,l(k))) when each variable z(k,l(k)) takes the EGPS optimal value, said EGPS optimal value of the payoff is OPTPAY(k,l(k),i(k,l(k))),
a family of EGNPURL_PROBLEM(k,l(k)) elements called empirical Nash type pure problems and their solutions called empirical Nash type pure solutions, said elements are defined only when k and l(k) exist,
wherein k takes all values in K and l(k) takes all values in EGNPURL(k), and
wherein each EGNPURL_PROBLEM(k,l(k)) comprises of:
a set GAMEINFO(k,l(k)), said set is defined as in the case of EGGPURL_PROBLEM(k,l(k)),
a family of functions EGNPURL_FUN(k,l(k),i(k,l(k))),
wherein i(k,l(k)) takes all values in I(k,l(k)),
wherein each EGNPURL_FUN(k,l(k),i(k,l(k))) is a function of the functions PAY(k,l(k),i′(k,l(k))) wherein i′(k,l(k)) takes values in I(k,l(k)), said EGNPURL_FUN(k,l(k),i(k,l(k))) can be the function PAY(k,l(k),i(k,l(k))),
wherein each variable z(k,l(k)) in VAR(k,l(k)) is a variable in at least one EGNPURL_FUN(k,l(k),i(k,l(k))), for some i(k,l(k)) in I(k,l(k)), and
wherein if z belongs in VARS\VAR(k,l(k)) and EGNPURL_FUN(k,l(k),i(k,l(k))) depends on z then z belongs in PAYPAR(k,l(k)),
the formulation of a game problem,

| | |
|---|---|
| MAX | EGNPURL_FUN(k,l(k),i(k,l(k))), |

VARM(i(k,l(k)))
i(k,l(k)) in I(k,l(k)),
wherein the c-times take values in the interval that begins at T0(k,l(k)) and ends at T1(k,l(k)), and
wherein the solution, in the form of Nash equilibrium, of said game problem exists and the optimal value of each variable z(k,l(k)) in VAR(k,l(k)) is OPTVAR(k,l(k),z(k,l(k))), and
the empirical Nash type pure solution of EGNPURL_PROBLEM(k,l(k)), said solution is denoted by the prefix (ENPS), said solution comprises of:
the ENPS optimal value of each variable z(k,l(k)) in VAR(k,l(k)), said optimal value is defined to be OPTVAR(k,l(k),z(k,l(k))), and
the ENPS optimal value of each PAY(k,l(k),i(k,l(k))), said ENPS optimal value is the value of PAY(k,l(k),i(k,l(k))) when each variable z(k,l(k)) takes the ENPS optimal value, said ENPS optimal value of the payoff is OPTPAY(k,l(k),i(k,l(k))),
a family of elements EGGMIXL_PROBLEM(k,l(k)) called empirical game type mixed problems and their solutions called empirical game type mixed solutions, said elements are defined only when k and l(k) exist,
wherein k takes all values in K and l(k) takes all values in EGGMIXL(k),
wherein for each value of k and l(k) there exists a EGGMIXL_PROBLEM(k,l(k)) in the family, and
wherein each EGGMIXL_PROBLEM(k,l(k)) comprises of:
a set GAMEINFO(k,l(k)), said set is defined as in the case of EGGPURL_PROBLEM(k,l(k)),
a function EGGMIXL_FUN(k,l(k)),
wherein EGGMIXL_FUN(k,l(k)) is a function of the functions PAY(k,l(k),i(k,l(k))) wherein i(k,l(k)) takes values in I(k,l(k)), said EGGMIXL_FUN(k,l(k)) can be the difference
PAY(k,l(k),i(k,l(k)))−PAY(k,l(k),ci(k,l(k))),
wherein EGGMIXL_FUN(k,l(k)) depends on all variables in VAR(k,l(k)), and
wherein if z belongs in VARS\VAR(k,l(k)) and EGGMIXL_FUN(k,l(k)) depends on z then z belongs in PAYPAR(k,l(k)),
a functional EGGMIXL_EXPFUN(k,l(k)), said functional is the functional defined by the function EGGMIXL_FUN(k,l(k)), wherein the arguments of the functional are the measures PROBM(i(k,l(k))),
the formulation of a zero sum game problem MAX MIN EGGMIXL_EXPFUN(k,l(k)) PROBM(i(k,l(k))) PROBM(ci(k,l(k))),
wherein ci(k,l(k)) denotes the element in I(k,l(k))\{i(k,l(k))},
wherein the c-times take values in the interval that begins at T0(k,l(k)) and ends at T1(k,l(k)), and
wherein the solution of said game problem exists and the optimal value of each variable PROBM(i(k,l(k))) is OPTPROBM(k,l(k),i(k,l(k))), and
the empirical game type mixed solution of EGGMIXL_PROBLEM(k,l(k)), said solution is denoted by the prefix (EGMS), said solution comprises of:
the EGMS optimal value of each variable PROBM(i(k,l(k))), said optimal value is defined to be OPTPROBM(k,l(k),i(k,l(k))),
the EGMS optimal value of each PAY(k,l(k),i(k,l(k))), said optimal value of PAY(k,l(k),i(k,l(k))) is OPTPAY(k,l(k),i(k,l(k))), and
the EGMS optimal value of each PAY(k,l(k),i(k,l(k))), said EGPS optimal value is the value of PAY(k,l(k),i(k,l(k))) when each variable z(k,l(k)) takes the EGMS optimal value, said EGPS optimal value of the payoff is OPTPAY(k,l(k),i(k,l(k))),
a family of elements EGNMIXL_PROBLEM(k,l(k)) called empirical Nash type mixed problems and their solutions called empirical Nash type mixed solutions, said elements are defined only when k and l(k) exist,
wherein k takes all values in K and l(k) takes all values in EGNMIXL(k),
wherein for each value of k and l(k) there exists a EGNMIXL_PROBLEM(k,l(k)) in the family, and
wherein each EGNMIXL_PROBLEM(k,l(k)) comprises of:
a set GAMEINFO(k,l(k)), said set is defined as in the case of EGGPURL_PROBLEM(k,l(k)),
a family of functions EGNMIXL_FUN(k,l(k),i(k,l(k))),
wherein i(k,l(k)) takes all values in I(k,l(k)),
wherein each EGNMIXL_FUN(k,l(k),i(k,l(k))) is a function of the functions PAY(k,l(k),i′(k,l(k))) wherein i′(k,l(k)) takes values in I(k,l(k)), said EGNMIXL_FUN(k,l(k),i(k,l(k))) can be the function PAY(k,l(k),i(k,l(k))),
wherein each variable z(k,l(k)) in VAR(k,l(k)) is a variable in at least one
EGNMIXL_FUN(k,l(k),i(k,l(k))), for some i(k,l(k)) in I(k,l(k)), and
wherein if z belongs in VARS\VAR(k,l(k)) and EGNMIXL_FUN(k,l(k),i(k,l(k))) depends on z then belongs in PAYPAR(k,l(k)),
a family of functionals EGNMIXL_EXPFUN(k,l(k),i(k,l(k))),
wherein i(k,l(k)) takes all values in I(k,l(k)),
wherein each
EGNMIXL_EXPFUN(k,l(k),i(k,l(k))) is the functional defined by the function EGNMIXL_FUN(k,l(k),i(k,l(k))), and
wherein the arguments of the functionals are the measures PROBM(i′(k,l(k))) wherein i′(k,l(k)) belongs in I(k,l(k)),
the formulation of a game problem

| | |
|---|---|
| MAX | EGNMIXL_EXPFUN(k,l(k)) |

PROBM(i(k,l(k)))
, i(k,l(k)) in I(k,l(k)),
wherein the c-times take values in the interval that begins at T0(k,l(k)) and ends at T1(k,l(k)), and
wherein the solution, in the form of Nash equilibrium, of said game problem exists and the optimal value of each variable PROBM(i(k,l(k))) is OPTPROBM(k,l(k),i(k,l(k))), and
the empirical Nash type mixed solution of EGNMIXL_PROBLEM(k,l(k)), said solution is denoted by the prefix (ENMS), said solution comprises of:
the ENMS optimal value of each variable PROBM(i(k,l(k))), said optimal value is defined to be OPTPROBM(k,l(k),i(k,l(k))),
the ENMS optimal value of each PAY(k,l(k),i(k,l(k))), said optimal value of PAY(k,l(k),i(k,l(k))) is OPTPAY(k,l(k),i(k,l(k))), and
the ENMS optimal value of each PAY(k,l(k),i(k,l(k))), said ENMS optimal value is the value of PAY(k,l(k),i(k,l(k))) when each variable z(k,l(k)) takes the ENMS optimal value, said ENMS optimal value of the payoff is OPTPAY(k,l(k),i(k,l(k))),
a family of elements called other type problems OL_PROBLEM(k,l(k)) and their solutions OL_S(k,l(k)), said elements are defined only when k and l(k) exist,
wherein k takes all values in K and l(k) takes all values in OL(k), and
wherein each OL_S(k,l(k)) comprises of:
the set VAR(k,l(k)) of variables,
a partition of VAR(k,l(k)) into two subsets OL_PURVAR(k,l(k)) and OL_MIXVAR(k,l(k)),
wherein OL_PURVAR(k,l(k)) is not vacuum if PUROL(k) is not vacuum and l(k) belongs in PUROL(k),
wherein OL_MIXVAR(k,l(k)) is not vacuum if MIXOL(k) is not vacuum and l(k) belongs in MIXOL(k), and
wherein OL_MIXVAR(k,l(k)) does not contain any element that belongs in NIVAR∪NOVAR∪NNVAR,
a family of functions OPTVAR(k,l(k),z(k,l(k))), said functions exist only if k and l(k) and z(k,l(k)) exist,
wherein l(k) belongs in PUROL(k) and z(k,l(k)) takes all values in OL_PURVAR(k,l(k)), and
wherein the set of variables of each OPTVAR(k,l(k),z(k,l(k))) is the set OPTVARPAR(k,l(k),z(k,l(k))),
wherein OPTVARPAR(k,l(k),z(k,l(k))) consists of elements in VAR(k′) for one or more k′ in K such that k′ is smaller than k, and
wherein for each value of the variables in OPTVARPAR(k,l(k),z(k,l(k))) the function OPTVAR(k,l(k),z(k,l(k))) takes values in the domain of the variable z(k,l(k)), and
a function OPTPROBM(k,l(k)), said function exists only if k and l(k) exist,
wherein l(k) belongs in MIXOL(k), and
wherein the set of variables of OPTPROBM(k,l(k)) is the set OPTPROBMPAR(k,l(k)),
wherein OPTPROBMPAR(k,l(k)) consists of elements in VAR(k′) for one or more k′ in K such that k′ is smaller than k, and
wherein for each value val(z) of each variable z in OPTPROBMPAR(k,l(k)) the value of the function OPTPROBM(k,l(k)) is a probability measure on OL_MIXVAR(k,l(k)),
the sets PURVAR(k,l(k)), said sets are defined only when k and l(k) exist,
wherein k takes all values in K and l(k) takes all values in PURL(k)∪PUROL(k), and
wherein each PURVAR(k,l(k)) is defined by:
if l(k) belongs in PURL(k) then PURVAR(k,l(k)) is the set VAR(k,l(k)) and
if l(k) belongs in PUROL(k) then PURVAR(k,l(k)) is the set OL_PURVAR(k,l(k)),
the set RECOPTVAR, said set consists of all elements RECOPTVAR(k,l(k),z(k,l(k))), said elements are defined by induction on k, wherein k takes all values in the interval K={0, 1, . . . , Kmax}, in the following steps:
each RECOPTVAR(0,l(0),z(0,l(0))) is defined to be OPTVAR(0,l(0),z(0,l(0))),
wherein l(0) takes all values in PURL(0)∪PUROL(0) and z(0,l(0)) takes all values in PURVAR(0,l(0)), and
if RECOPTVAR(k′,l′(k′),z′(k′,l′(k′))) are defined for all k′ in {0, 1, . . . , k} and all l′(k′) in PURL(k′)∪PUROL(k′) and all z′(k′,l′(k′)) in PURVAR(k′,l′(k′))
then
each RECOPTVAR(k+1,l(k+1),z(k+1,l(k+1))) is defined to be OPTVAR(k+1,l(k+1),z(k+1,l(k+1))),
wherein l(k+1) takes all values in PURL(k+1)∪PUROL(k+1) and z(k+1,l(k+1)) takes all values in PURVAR(k+1,l(k+1)), and
wherein each z′(k′,l′(k′)) that belongs in the intersection of PURVAR(k′,l′(k′)) and OPTVARPAR(k+1,l(k+1),z(k+1,l(k+1))) is replaced with RECOPTVAR(k′,l′(k′),z′(k′,l′(k′))),
wherein k′ takes all values in {0, 1, . . . , k},
wherein l′(k′) takes all values in PURL(k′)∪PUROL(k′), and
wherein z′(k′,l′(k′)) takes all values in the intersection of PURVAR(k′,l′(k′)) and OPTVARPAR(k+1,l(k+1),z(k+1,l(k+1))),
the set RECOPTPROBM, said set is the union of the sets RECOPTPROBM1 and RECOPTPROBM2,
wherein RECOPTPROBM1 consists of all RECOPTPROBM(k,l(k),i(k,l(k))),
wherein k takes all values in K and l(k) takes all values in MIXL(k) and i(k,l(k)) takes all values in I(k,l(k)), and
wherein each RECOPTPROBM(k,l(k),i(k,l(k))) is defined to be OPTPROBM(k,l(k),i(k,l(k))) wherein furthermore each z′(k′,l′(k′)) that belongs in the intersection of PURVAR(k′,l′(k′)) and OPTPROBMPAR(k,l(k),i(k,l(k))) is replaced with RECOPTVAR(k′,l(k′),z′(k′,l′(k′))),
wherein k′ takes all values in {0, 1, . . . , k−1},
wherein l′(k′) takes all values in PURL(k′)∪PUROL(k′), and
wherein z′(k′,l′(k′)) takes all values in the intersection of PURVAR(k′,l′(k′)) and OPTPROBMPAR(k,l(k),i(k,l(k))), and
wherein RECOPTPROBM2 consists of all RECOPTPROBM(k,l(k)),
wherein k takes all values in K and l(k) takes all values in MIXOL(k), and
wherein each RECOPTPROBM(k,l(k)) is defined to be OPTPROBM(k,l(k)) wherein furthermore each z′(k′,l′(k′)) that belongs in the intersection of PURVAR(k′,l′(k′)) and OPTPROBMPAR(k,l(k)) is replaced with RECOPTVAR(k′,l(k′),z′(k′,l′(k′))),
wherein k′ takes all values in {0, 1, . . . , k−1},
wherein l′(k′) takes all values in PURL(k′)∪PUROL(k′), and
wherein z′(k′,l′(k′)) takes all values in the intersection of PURVAR(k′,l′(k′)) and OPTPROBMPAR(k,l(k)),
a family of functions F(i),
wherein i takes all values in I,
wherein for each i there exists one F(i), and
wherein each F(i) depends on variables that belong in a subset VARF(i) of VARS, and
the mixed recursive optimal solution of the ac-game with respect to the particular mixed recursive method, said solution is denoted the prefix (MRS), said solution comprises of:
the MRS optimal values of all variables z(k,l(k)) that belong in PURVAR(k,l(k)) in the ac-game,
wherein the MRS optimal value of z(k,l(k)) is defined to be RECOPTVAR(k,l(k),z(k,l(k))),
the MRS optimal values of all measure variables PROBM(i(k,l(k)))
wherein k takes all values in K and l(k) takes all values in MIXL(k) and i(k,l(k)) takes all values in I(k,l(k)), and
wherein the MRS optimal value of PROBM(i(k,l(k))) is defined to be RECOPTPROBM(k,l(k),i(k,l(k))),
the MRS optimal values of all measure variables PROBM(k,l(k)),
wherein k takes all values in K and l(k) takes all values in MIXOL(k), and
wherein the MRS optimal value of PROBM(k,l(k)) is defined to be RECOPTPROBM(k,l(k)), and
the MRS optimal value of the payoff P(M(i)) of each c-coalition M(i) in the ac-game,
wherein i takes all values in I, and
wherein each MRS optimal value is defined by:
define RECF(i) to be the function F(i) wherein furthermore each z(k,l(k)) in the intersection of VARF(i) and PURVAR(k,l(k)) is replaced by RECOPTVAR(k,l(k),z(k,l(k))),
wherein k takes all values in K,
wherein l(k) takes all values in PURL(k)∪PUROL(k), and
wherein z(k,l(k)) takes all values in the intersection of PURVAR(k,l(k)) and VARF(i),
define EXPRECF(i) to be the expectation of RECF(i) with respect to the product of all measures RECOPTPROBM(k,l(k),i(k,l(k))) and RECOPTPROBM(k,l(k)), wherein it is assumed that after the integrations are performed the resulting expression EXPRECF(i) does not depend on any variable that belongs in VARS, and
define the MRS optimal value of the payoff P(M(i)) to be EXPRECF(i).

5. The method of claim 4 wherein furthermore:
if F(i) depends on a variable z′ that is a c-time that belongs in a ac1(a′)-subgame for some ae-game a′ in the ac-game
then F(i) depends on all c-times in the ac1(a′)-subgame and furthermore depends on the minimum value of the set of said c-times, wherein i takes all values in I.

6. The method of claim 5 wherein furthermore the sets OL(k) are vacuum.

7. The method of claim 4 wherein furthermore:
the subset of c-coalitions is the set of all c-coalitions in the ac-game,
the set K and the set L(k) consist of only one element,
the set I(k,l(k)) is equal to I and i(k,l(k)) is i,
EL(k)=OL(k) are equal to the Vacuum Set,
VARM(i(k,l(k)))=VARS(M(i)), and
if SL(k) is non vacuum
then PAY(k,l(k))=P(M(i)) and F(i)=P(M(i)),
if GL(k) is non vacuum
then PAY(k,l(k))=P(M(i))−P(M(ci)) and F(i)=P(M(i)), and
if NL(k) is non vacuum
then PAY(k,l(k),i(k,l(k)))=F(i)=P(M(i)).

8. The method of claim 7 wherein furthermore all ae-games in the ac-game solved by the recursive solution are e-games.

9. The method of claim 7 wherein furthermore the set of variables VAR consists of c-times.

10. The method of claim 7 wherein furthermore all variables take discrete values.

11. The method of claim 9 wherein furthermore NL(k)=SL(k) are equal to the Vacuum Set.

12. The method of claim 9 wherein furthermore GL(k)=SL(k) are equal to the Vacuum Set.

13. The method of claim 7 wherein furthermore NL(k)=GL(k) are equal to the Vacuum Set.

14. The method of claim 4 wherein furthermore:
the ac-game solved by the recursive solution contains ae-games of order at most 1,
the subset of c-coalitions is the set of all c-coalitions in the ac-game,
the set K and the set L(k) consist of only one element,
the set I(k,l(k)) is equal to I and i(k,l(k) is i, NL(k)=SL(k)=GL(k)=OL(k) are equal to the Vacuum Set, VARM(i(k,l(k)))=VARS(M(i)), and PAY(k,l(k),i(k,l(k)))=F(i)=P(M(i)).

15. The method of claim 14 wherein furthermore EUL(k)=EGL(k) are equal to the Vacuum Set.

16. The method of claim 14 wherein furthermore EUL(k)=ELL(k)=EGGL(k) are equal to the Vacuum Set.

17. The method of claim 14 wherein furthermore EUL(k)=ELL(k)=EGNL(k) are equal to the vacuum Set.

18. The method of claim 4 wherein furthermore:
k takes values in the interval K={0, 1, . . . , Kmax} wherein Kmax is equal to MAXN wherein MAXN is the maximum order of ae-games in the ac-game,
the sets OL(k) are vacuum for all k in K.
for each k in K there exist one to one map from the set L(k) onto the set of all ae-games of order k in the ac-game, wherein to the element l(k) corresponds the ae-game a(k,l(k)),
the ac-game is written in realization form as {A(j): j in J}
wherein each realization is given by A(j)==(a(j,0), a(j,1), . . . , a(j,k), a(j,k+1), . . . , a(j,k(j)))
wherein k(j) belongs in K,
for all k in K and all l(k) in L(k) and all a(k,l(k)) that are not leaves the ac1(a(k,l(k)))-subgame with root the ae-game a(k,l(k)) of order k is written as ac1(a(k,l(k)))=={A (j′(k,l(k))): j′(k,l(k)) in J′(k,l(k))}
wherein each realization is A(j′(k,l(k)))==(a(k,l(k)), b(j′(k,l(k)))),
said realization is written also as A(j′(k,l(k)))==(a(j, k), a(j, k+1))
wherein a(k,l(k)) is the ae-game a(j,k) and b(j′(k,l(k))) is the ae-game a(j,k+1) for some j in J,
for all k in K and all l(k) in L(k) and all a(k,l(k)) that are not leaves the set VAR(k,l(k)) consists of all c-times in the ac1(a(k,l(k)))-subgame, all additional variables that belong in the sets ADVAR(a), all non-optimization variables that belong in NOVAR(a), all non-Nash variables that belong in NNVAR(a) and all non-Isaacs variables that belong in NIVAR(a), wherein a is an ae-game in the ac1(a(k,l(k)))-subgame,
for all k in K and all l(k) in L(k) and all a(k,l(k)) that are leaves the set VAR(k,l(k)) consists of all additional variables that belong in the ADVAR(a(k,l(k))), all non-optimization variables that belong in NOVAR(a(k,l(k))), all non-Nash variables that belong in NNVAR(a(k,l(k))) and all non-Isaacs variables that belong in NIVAR(a(k,l(k))),
for all k in K and all l(k) in L(k) the set PAYPAR(k,l(k)) is equal to {t0(a(k,l(k))} wherein t0(a(k,l(k)) is the time the differential game in ae-game a(k,l(k)) begins, said ae-game is either a leaf or the root of the ac1(a(k,l(k)))-subgame,
there exist functions P(M(i), a(j,k)) called the payoff of c-coalition M(i) in ae-game a(j,k) in the ac-game, for all i in I, all j in J and all k in K,
there exist functions P(M(i),k,l(k)),
wherein k takes all values in K and l(k) takes all values in L(k) and takes all values in I,
wherein each P(M(i),k,l(k)) depends on variables in VAR(k,l(k)) and on parameters in PAYPAR(k,l(k)),
wherein if P(M(i),k,l(k)) depends on a c-time in VAR(k,l(k)) then P(M(i),k,l(k)) depends on all c-times in VAR(k,l(k)) and furthermore depends on the minimum value of the set of said c-times, for all i in I all k in K and all l(k) in L(k),
wherein if a(k,l(k)) is a leaf a(j,k(j)) then each P(M(i),k,l(k)) is the payoff P(M(i), a(j,k(j))) of c-coalition M(i) in the ae-game a(j,k(j)), and
wherein if a(k,l(k)) is not a leaf then P(M(i), k, l(k))==SUM SIG(A(j′)) P(M(i), A(j′)),
wherein j′=j′(k,l(k)) and J′=J′(k,l(k)),
wherein the sum is over all j′ in J′,
wherein each SIG(A(j′)) is a function that has the following property:
if realization A(j′″) of the ac1(a(k,l(k))-subgame is played then SIG(A(j′)) takes the value zero for all j′″ and j′ in J′ such that j′″ is different from j′, said function can be the characteristic function of the domain DCT(j′) that corresponds to realization A(j′), and
wherein P(M(i), A(j′)) is defined by
$$P ( M ( i ) , A ( {j}^{′} ) ) == P ( M ( i ) , a ( k , 1 ( k ) ) ) + {P}^{″} ( M ( i ) , b ( {j}^{′} ) ) ,$$
wherein P(M(i),a(k,l(k)) is the given payoff of M(i) in ae-game a(k,l(k)), and
wherein
if b(j′) of order k+1 is written as b(k+1,l(k+1)) for some l(k+1) in L(k+1)
then
P″(M(i), b(j′)) is defined to be the optimal value OPTP(M(i),k+1,l(k+1)) of the given function P(M(i),k+1,l(k+1)), said optimal value is defined by:
if l(k+1) belongs in PURL(k+1)
then
OPTP(M(i),k+1,l(k+1)) is defined to be the value of P(M(i),k+1,l(k+1)) when the variables z(k+1,l(k+1)) in VAR(k+1,l(k+1)) take the optimal values OPTVAR(k+1,l(k+1),z(k+1,l(k+1))), and
if l(k+1) belongs in MIXL(k+1)
then
OPTP(M(i),k+1,l(k+1)) is defined to be the expected value of P(M(i),k+1,l(k+1)) with respect to the optimal measures OPTPROBM(k+1,l(k+1),i(k+1,l(k+1))), and
the following are true:
F(i) is defined to be P(M(i),0,l(0))) for all i in I,
if l(k) belongs in SL(k)
then PAY(k,l(k)) is defined to be P(M(i′),k,l(k)), wherein i′ belongs in I(k,l(k)),
if l(k) belongs in GL(k)
then PAY(k,l(k)) is defined to be P(M(i′),k,l(k))−P(M(ci′),k,l(k)), wherein i′ and ci′ belong in I(k,l(k)), and
if l(k) belongs in NL(k)∪EL(k)
then PAY(k,l(k),i(k,l(k))) is defined to be P(M(i′),k,l(k)), wherein i′=i(k,l(k)) and i′ belongs in I(k,l(k)).

19. The method of claim 18 wherein furthermore:
GL(k)=NL(k)=SL(k)=Vacuum Set, for all k in K.

20. The method of claim 18 wherein furthermore:
EUL(k)=EGL(k)=GL(k)=NL(k)=SL(k)=Vacuum Set, for all k in K.

21. The method of claim 1 wherein furthermore if P(Mi) depends on a variable z′ that is a c-time that belongs in a ac1(a′)-subgame for some ae-game a′ in the ac-game then P(Mi) depends on all c-times in the ac1(a′)-subgame and furthermore depends on the minimum value of set of said of c-times, wherein i takes all values in ID.
